(19) United States
(12) Patent Application Publication
(10) Pub. No.: US 2003/0212620 A1
(43) Pub. Date: Nov. 13, 2003

(54) Systems and methods for authorizing transactions

(75) Inventor: Lynn Holm Blagg, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/373,637

(22) Filed: Feb. 24, 2003

Related U.S. Application Data
(63) Continuation-in-part of application No. 10/319,422, filed on Dec. 12, 2002.
(63) Continuation-in-part of application No. 10/237,572, filed on Sep. 9, 2002.
(63) Continuation-in-part of application No. 10/172,378, filed on Jun. 13, 2002.
(63) Continuation-in-part of application No. 09/298,505, filed on Apr. 23, 1999.
(63) Continuation-in-part of application No. 09/298,521, filed on Apr. 23, 1999.
(63) Continuation of application No. 09/298,417, filed on Apr. 23, 1999.

(51) Int. Cl. G06F 17/60

(52) U.S. Cl. 705/35

(57) ABSTRACT

Among other things, the present invention provides systems and methods for authorizing transactions. The methods include receiving a transaction request, determining if one or more of a velocity limit, a geographic limit, a merchant limit, and/or the like. These determined limit(s) are then used to authorize the transaction request. Other methods provide a mechanism for defining limits in relation to one or more entities. The systems include various components useful in implementing the disclosed methods.

### CROSS-REFERENCES TO RELATED APPLICATIONS

The present application is a continuation-in-part of multiple U.S. patent applications commonly assigned to First Data Corporation including:

(1) U.S. patent application Ser. No. 10/319,422 (Attorney Docket No. 020375-022050) entitled “Authorizing Transactions Associated With Accounts”, and filed on Dec. 12, 2002, which is a continuation of U.S. patent application Ser. No. 09/298,417, entitled “Method for Processing a Group of Accounts Corresponding to Different Products”, and filed on Apr. 23, 1999.

(2) U.S. patent application Ser. No. ______ (Attorney Docket No. 020375-022040) entitled “Chasing Rewards Associated With Accounts”, and filed Feb. 21, 2003.

(2) U.S. patent application Ser. No. 09/298505 entitled “Method for Linking Accounts Corresponding to Different Products Together to Create a Group”, and filed on Apr. 23, 1999.

(3) U.S. patent application Ser. No. 09/298521 entitled “Method for Defining a Relationship Between an Account and a Group”, and filed on Apr. 23, 1999.

(4) U.S. patent application Ser. No. 10/172378 entitled “System and Methods for Accessing and Modifying Usage Parameters Associated with a Financial Transaction Account”, and filed on Jun. 13, 2002, which is a continuation-in-part of the following U.S. patent application Ser. Nos.: 09/298,417 filed Apr. 23, 1999, entitled “Methods for Processing a group of Accounts Corresponding to Different Products”; 09/298,505 filed Apr. 23, 1999, entitled “Method for Linking Accounts Corresponding to Different Products Together to Create a Group”; and 09/298,521 filed Apr. 23, 1999, entitled “Method for Defining a Relationship Between an Account an a Group”.

(5) U.S. patent application Ser. No. 10/237,572 entitled “Multiple Credit Line Presentation Instrument”, and filed on Sep. 9, 2002.

All of the aforementioned patent applications are assigned to the assignee of the present invention, and the entirety of each of the aforementioned applications is incorporated herein by reference for all purposes.

### BACKGROUND OF THE INVENTION

The present invention relates to processing transaction requests in relation to an account, or an account group. More particularly, the present invention provides systems and methods for authorizing transactions.

In a simple case, a credit card, or other presentation instrument may be provided to consummate a financial transaction. In the case of a credit card, it can be determined whether the transaction, or charge to be applied to the credit card is within a credit limit associated with the credit card. Where the charge is within the credit limit, the charge is allowed, and the charge is denied where the charge exceeds the credit limit. This approach is inflexible and can result in authorizing charges that are not desired, while denying other charges that are desirable.

In some cases, a credit card processor monitors a rate at which charges are accrued on a credit card. Where the amount within a short period exceeds some preset limit, additional charges can be denied as it may appear that fraud is ongoing. Such monitoring of rate expenditures is done over a relatively short period of time. Further, such an approach dos not allow a user of the credit card to set the rate at which charges will be denied. Thus, such an approach is not useful for budgeting or other personal purposes.

Thus, there exists a need in the art to provide advanced systems and methods for authorizing a variety of transactions. As will be appreciated from the following disclosure, the systems and methods according to the present invention address these, and a number of other problems related to authorizing transactions.

### BRIEF SUMMARY OF THE INVENTION

Among other things, the present invention provides systems and methods for authorizing transactions. The methods include receiving a transaction request, determining if one or more of a velocity limit, a geographic limit, a merchant limit, and/or the like are used. These determined limit(s) are then used to authorize the transaction request. The systems include various components useful in implementing the disclosed methods.

One embodiment of the present invention includes providing a user interface that queries a user for an entity to which a limit will be defined. Such entities can be, for example, a person, a presentation instrument, an automobile, an electronic device, or the like. A limit can then be received in relation to the entity, or combination thereof, and stored in a database. When a transaction is later requested, the limit can be queried to determine if the transaction is within the limit. Such limits can include, but are not limited to, velocity limits, geographic limits, merchant limits, credit limits, and the like.

Another embodiment of the present invention provides methods for authorizing financial transactions that include receiving a request to perform a financial transaction in relation to an entity. Such an entity can be, but is not limited to, an automobile, a presentation instrument, a person, an account, a mobile electronic device, any combination of the aforementioned, or the like. An automobile can request a transaction, such as a gasoline purchase, by including a transmitter or FOB that identifies the automobile to a point-of-sale device. Alternatively, the point-of-sale device can read a license plate of the automobile and use such an identification to authorize a transaction. In addition, a mobile electronic device, such as a cell phone, a pager, or a personal digital assistant can be used to request a transaction. This can be done by a point-of-sale device querying the mobile electronic device, or by the mobile electronic device initiating the transaction by, for example, calling a number indicated on the point-of-sale device. In other cases, a transaction can be initiated using a presentation instrument including, but not limited to, a credit card, a debit card, or the like. In yet other cases, an account number may be provided in relation to a transaction. Further, a person may be identified in relation to the transaction. This can include, for example, providing a person's social security number, or having a FOB carried by the person identify the person to a point-of-sale device. Based on this disclosure, one of ordinary skill in the art will recognize a number of other entities and/or combinations thereof to which a transaction request can be related.

As just one example, a transaction can be requested via a FOB associated with an automobile. As another example, a transaction can be requested via a combination of a FOB associated with an automobile and an FOB associated with a person. Of course, these are merely exemplary and many other transaction requests can be initiated via an automobile, a person, an account, a mobile device, and/or any combination thereof. In some cases, an entity can be a combination of two or more of the following: a presentation instrument, an automobile, an account, and a person.

The methods further include determining a velocity limit associated with the entity. Such a velocity limit can be, but is not limited to, an amount per month, an amount per week, a percentage of credit limit per month, and a percentage of credit limit per month. Thus, where a FOB associated with an automobile is used to initiate the transaction, a velocity limit associated with the automobile can be determined. Alternatively, where a combination of a FOB associated with an automobile, and one associated with a person is used, a velocity limit for the combination can be determined. In particular cases, the entity is a person, and the velocity limit is different for the person utilizing a first presentation instrument than for the person utilizing a second presentation instrument. In alternate cases, the entity is a presentation instrument, and the velocity limit is different for the presentation instrument when used by a first person than for the presentation instrument when used by a second person. Based on the disclosure provided herein, one of ordinary skill in the art will recognize a myriad of combinations that can utilize different velocity limits.

The transaction is authorized based at least in part on a previous financial transaction incurred in relation to the entity. Thus, for example, if the previous transaction(s) in combination with the immediate transaction would exceed the velocity limit, the immediate transaction is denied. Otherwise, the immediate transaction is authorized where other relevant criteria are met. In some cases, no other relevant criteria exist, while in other cases various relevant criteria, such as exceeding a credit limit can also be checked.

In one particular instance, a velocity limit associated with an individual account and a velocity limit associated with an account group are used to authorize a transaction. Thus, where authorizing a transaction will exceed either or both of the group limit and the account limit, the transaction can be denied.

In some instances, the methods can further include determining a geographic limit associated with the entity, and authorizing the financial transaction, wherein authorizing the financial transaction is based at least in part on a geographic location associated with the request. In such cases, an entity can be limited to use within a geographic region. Thus, for example, a credit card may be limited to use within twenty miles of an owner's location. Alternatively, a FOB associated with a car may be limited to a radius of one hundred miles from a defined location. A number of geographic limitations are possible within the scope of the present invention.

In yet other cases, the methods can further include determining a merchant limit associated with the entity, and authorizing the financial transaction based at least in part on a merchant associated with the request. As just one example, a FOB associated with an automobile may only be useful to purchase a certain brand of gasoline. Alternatively, a presentation instrument may not allow the purchase of jewelry, or any purchase initiated at a jewelry store. Based on this disclosure, one of ordinary skill in the art will recognize a myriad of other merchant limits that are possible. Such can limit purchases to a group of merchants, and/or to a class of goods or services. Thus, for example, a presentation instrument may only be capable of purchasing food items.

In other embodiments, authorization can be based on either a geographic limit or a merchant limit, and not a velocity limit. Alternatively, authorizations can be based on a combination of geographic and merchant limits, or a combination of geographic, merchant and velocity limits.

This summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram illustrating an exemplary relationship between a card processing and service provider, issuers and cardholders;

FIG. 2 is a block diagram illustrating an exemplary relationship between a card processing and service provider, an issuer and the cardholders within a group in accordance with an embodiment of the present invention;

FIG. 3 is a block diagram illustrating the relationship between a card processing and service provider, issuers and the cardholders within a group in accordance with an embodiment of the present invention;

FIG. 4A is a block diagram illustrating the files included in the group master data in accordance with an embodiment of the present invention;

FIG. 4B is a block diagram illustrating group master data in accordance with an embodiment of the present invention;

FIG. 5 is a flow diagram illustrating the steps for creating a group using new accounts in accordance with an embodiment of the present invention;

FIG. 6 is a flow diagram illustrating the steps for creating a group using existing accounts in accordance with an embodiment of the present invention;

FIG. 7A is a flow diagram illustrating the steps for adding a dependent account to a group in accordance with an embodiment of the present invention;

FIG. 7B is a flow diagram illustrating the steps for authorizing a transaction in accordance with an embodiment of the present invention;

FIGS. 8A and 8B are flow diagrams illustrating the steps for applying a payment in accordance with an embodiment of the present invention;

FIG. 9 is a flow diagram illustrating the steps for identifying intended recipients of statement data and providing statement data in accordance with an embodiment of the present invention;

FIG. 10 is a flow diagram illustrating the steps for redeeming group reward points in accordance with an embodiment of the present invention;

FIG. 11 illustrates a flow diagram of a method in accordance with an embodiment of the present invention for defining various authorization limits;

FIG. 12 illustrates a data structure in accordance with embodiments of the present invention for maintaining authorization limitations; and

FIG. 13 illustrates a flow diagram of a method in accordance with the present invention for authorizing a transaction.

### DETAILED DESCRIPTION OF THE INVENTION

Among other things, the present invention is directed to systems and methods for authorizing transactions. Such systems and methods can include use of a velocity limit, a geographic limit, a merchant limit, and/or combinations thereof in the authorization process. For the purposes of this document, a velocity limit is amount transacted over a period of time, where the period of time is five days or more. Thus, as one example, an authorization may be denied where more than one hundred dollars has been charged in a given one week period. A geographic limit is any limitation on a transaction based on physical location. Thus, for example, a geographic limit can limit transactions to a certain zipcode, or group of zipcodes. Alternatively, a geographic limit can limit transactions to within a defined radius of a location, such as within one hundred miles of an account owner's home. A merchant limit is any limit that restricts transactions to one or more merchants, and/or classes of goods or services. Thus, for example, a merchant limit may only allow for purchases of gasoline, or purchases at a defined retailer. In some embodiments, all of these limits can be user defined.

Some of the methods include forming account groups and utilizing the aforementioned limits in relation to the account groups. Such methods can include linking the accounts into a group by linking a financial record for each account to group master data for the group. The group master data includes information about the group and the group members, including group control settings, group aggregate data, and a group identifier. The financial records include information about the corresponding account, a relationship parameter specifying whether the corresponding account is a key account or a dependent account, and if the financial record corresponds to a dependent account, a dependent strategy identifier.

The relationship between a dependent account and the group is specified by a dependent strategy. A dependent strategy specifies group processing options for the dependent account. The relationship between a dependent account and the group can be changed by selecting a new dependent strategy.

The detailed description which follows is represented largely in terms of processes and symbolic representations of operations by a conventional computer. The processes and operations performed by the computer, in both a stand alone environment and a distributed computing environment, include the manipulation of signals by a processor and the maintenance of these signals within a data set, such as a database and a data structure. Each of these data sets and data structures are resident in one or more memory storage devices. Basically, a data set is a collection of related information in separate elements that are manipulated as a unit. A data structure is a structured organizational scheme that encapsulates data in order to support data interpretation and data operations. The data structure imposes a physical organization upon the collection of data stored within a memory storage device and represents specific electrical or magnetic elements.

For the purposes of this discussion, a method or process is generally conceived to be a sequence of computer executed steps leading to a desired result. These steps generally require physical manipulations of physical quantities. In addition, it should be understood that the methods and systems described herein are not related or limited to any particular computer (standalone or distributed) or apparatus. Furthermore, the methods and systems are not related or limited to any particular communication architecture. Thus, one skilled in the art will be able to implement the systems and methods of the present invention with general purpose machines or specially customized programmable devices according to the teachings described herein.

Referring now to the drawings, in which like numerals represent like elements throughout the several figures, aspects of the present invention and the preferred operating environment are described.

Card Processing and Service Provider, Issuers, and Cardholders

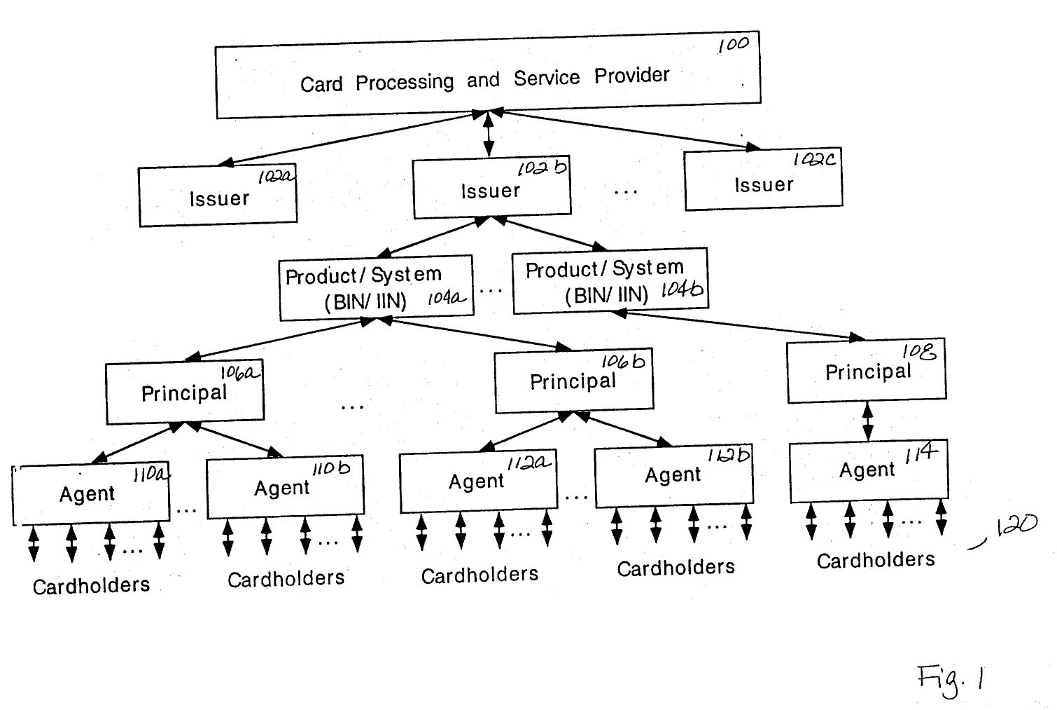

The processing of a credit card transaction typically involves the cardholder, a merchant, a merchant acquirer, the card issuer, and a card processing and service provider. FIG. 1 illustrates an exemplary relationship between a card processing and service provider 100, a number of issuers 102a, 102b . . . 102c, and a number of cardholders 120. The card processing and service provider 100 supports the issuers by authorizing and processing monetary transactions, as well as providing support for creating new accounts, modifying accounts, generating cardholder statements, applying payments to accounts, controlling communications to cardholders and building reward programs. An issuer, such as, issuer 102b, is typically a bank or other financial institution that issues one or more credit card products. The issuer manages transaction processing at the account level. An issuer typically manages a number of accounts using a hierarchy, such as the Product/System, Principal, and Agent hierarchy shown in FIG. 1. The cardholders 120 are typically individuals holding a credit card or charge card, such as a VISA™, MASTERCARD™, or private label card. In addition to the elements shown in FIG. 1, additional elements (not shown) may also be included. For example, additional issuers, Products/Systems, Principals, and Agents may exist.

An issuer can issue different types and versions of credit card products. For example, issuer 102b could offer a VISA product and a MASTERCARD™ product. Each product could be offered in standard, gold and platinum versions. The Product/System blocks shown in FIG. 1 correspond to different products. If issuer 102b issues a VISA™ product and a MASTERCARD™ product, then Product/System 104a could correspond to the VISA™ product and Product/System 104b could correspond to the MASTERCARD™ product. An issuer typically uses either a BIN (bank identification number) or an IIN (issuer identification number) to identify its different credit card products.

Issuers typically use additional levels of reporting structures below the Product/System level to manage large portfolios. FIG. 1 illustrates that below the Product/System level is the Principal level and below the Principal level is the Agent level. The divisions between the Principal level and the Agent level are typically defined by the issuer. Some issuers use the Principal level and the Agent level to make geographical divisions. For example, Principal block 106a could correspond to a geographic region, such as the southeast, and Agent block 110a could correspond to a state within that region. The cardholders 120 are located below the Agent level. As shown in FIG. 1, a number of cardholders can be associated with a single Agent. FIG. 1 illustrates an example of the hierarchical relationships that exist between an issuer and a cardholder. As will be apparent to those skilled in the art, alternative hierarchies are also possible.

An individual can hold a number of different cards corresponding to a number of different accounts. Although the same cardholder is associated with each of the accounts, each account is processed independently by the issuer. If several cardholders are in the same family, then each cardholder may hold several cards. In the case of a family, the cardholders may be related and the payments may be made from family funds, but each account is still processed independently. For example, Table 1 illustrates the credit cards held by a typical family including friends and co-workers.

TABLE 1

| | STANDARD | STANDARD | GOLD | VACATION | SICK | INSURANCE |
|---|---|---|---|---|---|---|
| Cardholder | VISA ™ | MC | MC | DAYS | DAYS | BENEFITS |
| MOTHER | Account 1 | | Account 2 | Account 7 | Account 9 | Account 11 |
| FATHER | | | Account 3 | | | Account 12 |
| SON | Account 5 | | | | | |
| DAUGHTER | | Account 6 | | | | |
| GRANDFATHER | | Account 8 | | | | |
| FRIEND | | | | | | Account 13 |
| CO-WORKER | | | | Account 14 | Account 10 | |

Each of the accounts shown in Table 1 is an independent account from the perspective of the entity maintaining the account, whether it be an issuer, an insurance provider, an employer, or the like. Thus, for example, the standard MASTERCARD™ account associated with the daughter (Account 6) is independent of the standard MASTERCARD™ account associated with the grandfather (Account 8) and the gold MASTERCARD™ account associated with the mother (Account 2) is independent of the gold MASTERCARD™ account associated with the father (Account 3). As illustrated, various accounts can be grouped including, but not limited to, financial accounts associated with one or more financial products, insurance benefit accounts, employer benefit accounts, and the like. Based on the disclosure provided herein, one of ordinary skill in the art will recognize a myriad of other account types that can also be included in a group, or otherwise used in relationship with the inventions disclosed herein. For example, a reward account, such as a frequent flyer miles account associated with one or more travel providers could be used in relation to the present inventions. The processing options used by the issuer to process the accounts shown in Table 1 can differ by product.

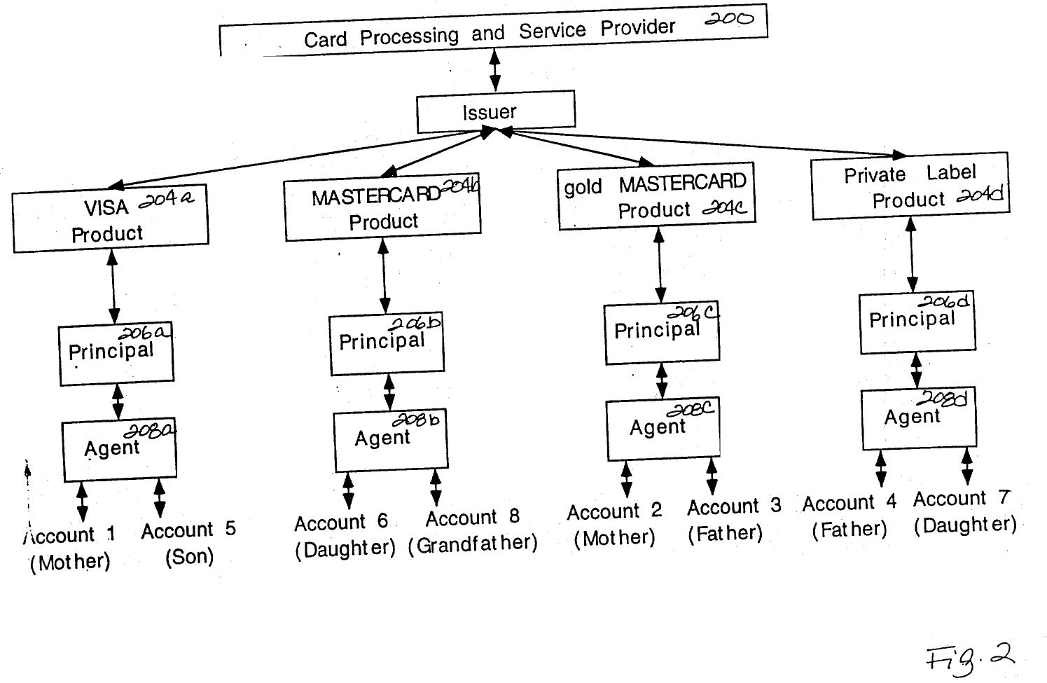

The relationships between the different accounts shown in Table 1, the issuer, and the card processing and service provider are illustrated by FIG. 2. The card processing and service provider 200 supports the issuer 202. The issuer 202 issues a variety of credit card products, including a standard VISA™ product 204a, a standard MASTERCARD™ product 204b, a gold MASTERCARD™ product 204c, and a private label product 204d. Account 1 and Account 5 are shown under the standard VISA product 204a, Account 6 and Account 8 are shown under the standard MASTERCARD™ product 204b, Account 2 and Account 3 are shown under the gold MASTERCARD™ product 204c, and Account 4 and Account 7 are shown under the private label product 204d.

Groups and Group Relationships

In accordance with an embodiment of the present invention, the accounts shown in Table 1 and FIG. 2 can be linked together to create a group. A group can include a number of accounts that correspond to a single issuer. By linking accounts into a group, group processing can be performed on the accounts that are members of the group while maintaining independent processing of each of the accounts. Each group has a primary owner. Generally the primary owner corresponds to a cardholder for a key account. For example, the standard VISA account held by the mother could be designated as the key account for the group shown in Table 1 and FIG. 2. The remaining accounts in the group are referred to as dependent accounts. The relationship between a dependent account and the group is independent of the relationship between the remaining dependent accounts and the group. Typically, the issuer defines the possible relationships between a dependent account and the group.

FIG. 2 shows one possible organization for a group. Other organizations are also possible. As shown in FIG. 2, the accounts in a group can be associated with different products. There are no restrictions on the placement of the accounts in a group at the Product/System, Principal or Agent levels. The accounts in a group can be split between different Products/Systems, Principals and Agents. The key account and a dependent account can be associated with the same Agent. Multiple dependent accounts can also be associated with the same Agent. The accounts associated with an Agent are not required to be in the same group (or any group at all).

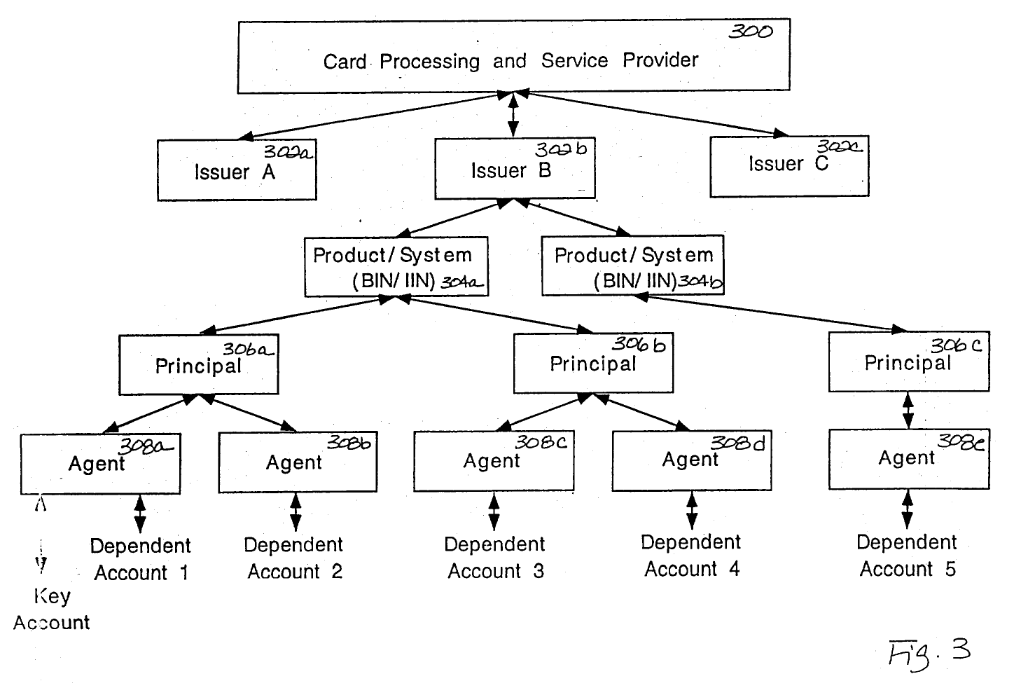

FIG. 3 shows an exemplary group where the key account and Dependent Account 1 are associated with the same Agent 308a. Dependent Account 2 is associated with a different Agent 308b, but is the same type of product 304a as the key account and Dependent Account 1. Dependent Account 3 is associated with a different Principal 306b than the key account, Dependent Account 1, and Dependent Account 2, but is the same type of product 304a. Dependent Account 4 is associated with a different Agent 308d than Dependent Account 3, but is associated with the same Principal 306b. Dependent Account 5 is a different product 304b than any of the other accounts in the group. Although FIG. 3 only shows a single group, additional groups or individual accounts can exist under the issuer 302b. Furthermore, additional groups can exist under the other issuers 302a, 302c.

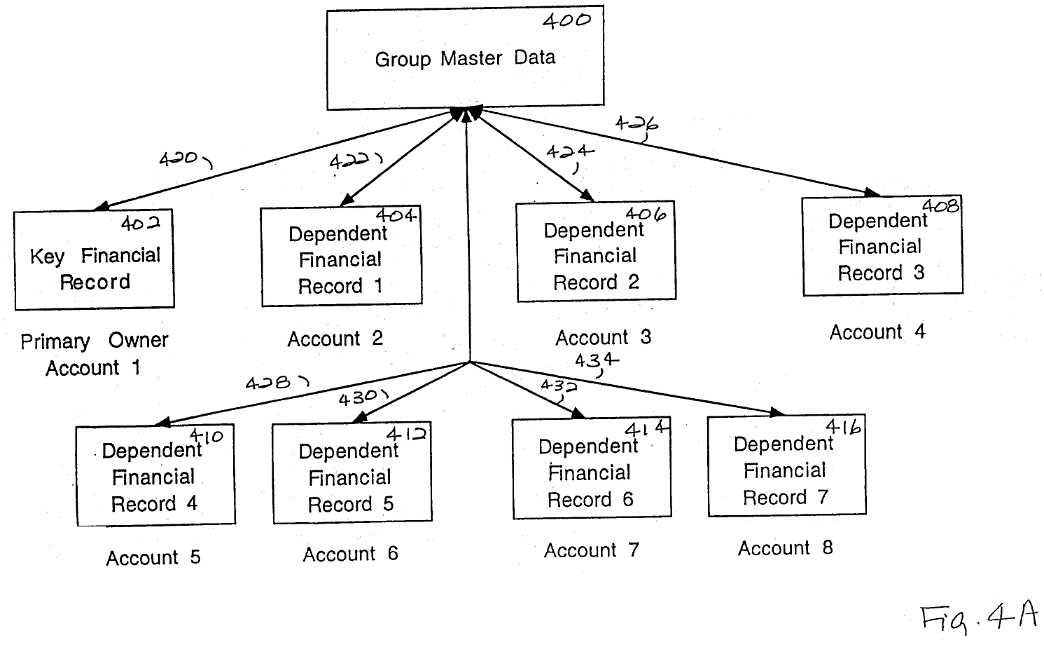

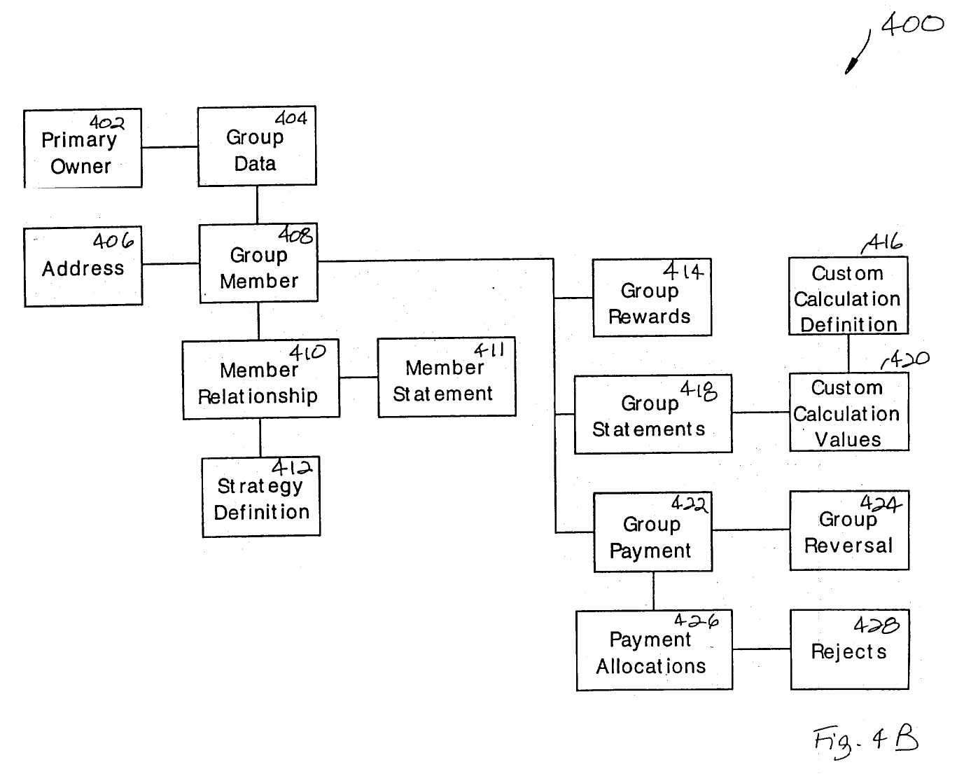

Linking the accounts into a group is accomplished by linking a financial record that corresponds to each account to group master data for the group. FIG. 4A illustrates the linking of the accounts shown in Table 1 into a group. The Group Master Data 400 includes information about the group, including group control settings, group aggregate data, and a group identifier. The Group Master Data 400 is discussed in more detail below in connection with FIG. 4B. The Key Financial Record 402 corresponds to the key or primary owner. The Key Financial Record 402 can also correspond to a key account held by the primary owner. In this example, the Key Financial Record 402 corresponds to the standard VISA™ account held by the mother. The relationship 420 between the Key Financial Record 402 and the Group Master Data 400 is a predefined relationship. Typically, the relationship is defined in part by the card processing and service provider and in part by the issuer.

In addition to the Key Financial Record, the group also includes Dependent Financial Records 404, 406, 408, 410, 412, 414, and 416 that correspond to the dependent accounts. Typically, a dependent account is associated with each dependent financial record. For example, Account 2 is associated with Dependent Financial Record 1 404. Each account is also associated with one or more cardholders, e.g. the mother is the cardholder associated with Account 2.

The dependent accounts in the group can cross product lines. In this example, Account 2 and Account 3 are MASTERCARD™ products, Account 4 and Account 7 are private label products, Account 5 is a VISA product, and Account 6 and Account 8 are MASTERCARD™ products. The relationship 422 between Dependent Financial Record 1 404 and the Group Master Data 400 is independent of the relationship between the remaining Dependent Financial Records and the Group Master Data.

The dependent accounts can also have different types of ownership. For example, the primary owner and a dependent cardholder can be jointly responsible for a dependent account, the primary owner can be responsible for a dependent account where a dependent cardholder is an authorized user, or a dependent cardholder can be solely responsible for a dependent account. In addition, a dependent cardholder can be jointly liable with the primary owner for the group liability. If a dependent cardholder is jointly liable with the primary owner for the group, then the dependent account is a jointly liable dependent account.

Group Master Data

The Group Master Data 400 is further illustrated in FIG. 4B. FIG. 4B illustrates a number of files 402-428. Each of the files includes records that contain information about the group and the accounts that are members of the group. The Group Data file 404 includes information about the group, such as a group identifier, a group cycle code, a group credit line, group available credit, and a group-collector code. The group identifier identifies the group. Each of the records associated with the group includes the group identifier.

A group cycle code indicates the cycle code for the group. If the group includes a key account, then the cycle code for the key account typically is used as the group cycle code. If the group does not include a key account, then the group cycle code can be a default cycle code or can be based upon the cycle code of one of the dependent accounts in the group. The group credit line specifies the credit available for the accounts in the group that authorize against the group credit line. The group available credit specifies the current credit available for the accounts in the group that authorize against the group credit line. The group collector code may be set once a collector is assigned to one of the accounts in the group. A collector may be assigned because the account is delinquent. If another account in the group becomes delinquent, then the group collector code is checked and the same collector is assigned to that account if a group collection option is used.

The Primary Owner file 402 includes information about the primary owner of the group. The primary owner is the individual that is liable for the group. If more than one individual is liable for the group, then those individuals are jointly liable for the group and information about the individuals in stored in the Primary Owner file 402. For example, a primary owner and a dependent cardholder could be jointly liable for the group. For simplicity, the term “primary owner” is used herein to include a single primary owner or joint primary owners. Every group has a primary owner. If the group includes a key account, then the key cardholder is the primary owner.

The Group Member file 408 includes a record for each of the accounts that is (or was) a member of the group. Each record includes an account number, an indication as to whether the account is a key account or a dependent account, and group membership information. A record is maintained for an account in the Group Member file 408 even if the account is delinked from the group. Each record includes group membership information which indicates when the account was linked to the group and if the account is no longer a member of the group, when the account was delinked from the group. The Address file 406 includes a record for each of the accounts that is (or was) a member of the group. Each record includes the mailing address of the cardholder associated with the account.

The Member Relationship file 410 includes a record for each of the accounts that is (or was) a member of the group. A member relationship record contains information about the strategy associated with an account. If the strategy associated with the account has changed, then the member relationship record contains information about the previous strategy or strategies, as well as the current strategy. The member relationship record also contains information about the effective dates of each strategy.

The Strategy Definition file 412 includes a record for each of the defined strategies. The strategy definition records include the parameters and the parameter values that define the strategies referred to in the member relationship records. If the definition of a strategy has changed, then the strategy definition record for that strategy also includes the parameter and the parameter values that defined the previous version or versions of the strategy, as well as the effective dates of each strategy definition.

The Member Statement file 411 includes records for each account that is (or was) a member of the group. Each record includes a number of fields that store statement data (monetary information) for the associated account. In addition, each record includes a flag that indicates whether the associated account cycles with the group (i.e. has the same cycle code as the group) or cycles independently. The information stored in the Member Statement file 411 is used to generate the group statement, dependent cardholder statement, and/or a courtesy statement.

The Group Statement file 418 includes records that contain group monetary and group non monetary information. The group monetary information includes the group balances, as well as the group credit line and group available credit for a particular statement. The group non monetary information includes the group payment due date. Typically, the group payment due date is the earliest due date of all the accounts of the group that are paid by the primary owner. The information stored in the Group Statement file 418 is used to generate the group statement.

The information in the Member Statement file 411 and the Group Statement file 418 is used to determine the initial break up of a group payment. The information is also used to support the on line display of statement information to an operator.

The Group Rewards file 414 includes a record for each of the reward programs for the group. Each record includes information about the reward program, such as a reward program identifier and the amount of group points accumulated in that reward program.

The Custom Calculation Definition file 416 and the Custom Calculation Values file 420 support customized group calculations that appear in a field on the group statement. Each custom calculation definition record includes a formula for a customized group calculation. Typically, a formula specifies that a customized group calculation is calculated using monetary elements from the accounts in the group. The value that is calculated using the formula is stored in a custom calculation values record.

The Group Payment file 422 includes a record for each group payment received. Each record includes the amount of the group payment and the date the group payment was received. The Payment Allocations file 426 includes a record for each group payment received. Each record indicates how the group payment was allocated among the accounts in the group. The Group Reversal file 424 includes a record for each group payment that has been reversed. If a group payment is reversed, then the reversal is made by referencing the Payment Allocation file 426 to determine how the payment was originally allocated.

The Rejects file 428 includes records of rejections detected during processing other than group processing. A record in the Rejects file 428 includes a rejection report that provides details of the rejection. As will be apparent to those skilled in the art, the files shown in FIG. 4B are exemplary group master data files. The group master data could be stored using alternative types of files and records.

Dependent Strategies

Typically, the relationship shown in FIG. 4A between the Dependent Financial Records 422, 424, 426, 428, 430, 432, 434 and the Group Master Data 400 is defined by a set of parameters. The parameters are typically provided by the card processing and service provider. A set of parameters and parameter values can be selected to create a customized dependent strategy. Either the card processing and service provider or the issuer can select the parameters and the parameter values to create a dependent strategy. Preferably, the card processing and service provider provides parameters and the issuer selects a set of parameter values that is suitable for a particular situation. Alternatively, the card processing and service provider could provide strategies rather than parameters to define the strategies. If the card processing and service provider provides strategies, then each of the issuers supported by the card processing and service provider chooses among the same group of strategies. However, if the card processing and service provider provides parameters, then each issuer can customize the strategies offered to its customers. In some embodiments the dependent strategies are labeled. For example, a dependent strategy for a college-age child residing at school may have one label, whereas a dependent strategy for a second account for the primary owner may have another label.

A dependent strategy specifies the relationship between a dependent account and the group by specifying group processing options for the account. The group processing options provide flexibility in the relationships between the dependent accounts and the group and provide for automatic processing at the group level. Typically, the dependent strategy includes parameters that define how transactions are authorized for the dependent account, as well as whether payment for the account is due from the primary owner or from the dependent account cardholder. In addition the dependent strategy includes options for payment application, statement generation, cardholder communications, and reward pooling.

The parameter values could be selected to create a dependent strategy appropriate for a dependent, college age child that resides at school. The parameter values could be selected so that the child is liable for the account and the parent receives information about the activity of the account. Alternatively, the parameter values could be selected so that the parent and the child are jointly liable for the account and that both the parent and the child receive information about the activity of the account at their respective residences. Another strategy could be created for a high school age child living at home. The parameter values could be selected so that the primary owner, typically the parent, is financially liable for the account and the account has a predetermined limit. The primary owner could set the limit on the account.

The parameter values could also be selected to create a strategy for a dependent account held by the primary owner. The primary owner could use the key account and the dependent account to segregate expenses. The parameter values could be selected so that the primary owner is liable for the account and detailed information about the account is included on the group statement. As will be apparent to those skilled in the art, additional strategies can also be created to address the needs of other situations.

Creating a Group

There are a number of ways that a group can be created. One way to create a group is to create a group using new accounts. Another way to create a group is to link a number of existing accounts together. Typically, a group is created by an issuer. The group can be created using either on line or batch processing. Once the first account is identified as being a member of the group, the group master data is automatically generated. Once a group is created, additional accounts can be added to the group or existing accounts can be removed from the group.

Business rules are used to insure that the relationships between the accounts in the group are valid. The business rules define the types of accounts that can be linked together in a group. Typically, the business rules are promulgated by the card processing and service provider. The business rules are checked whenever group relationships are impacted. For example, the business rules are checked when a group is created or an account is added to or removed from a group. Shown below is a list of typical business rules. As will be apparent to those skilled in the art, the number and types of business rules may vary from that shown below.

(1) A group must have one and only one primary owner.

(2) A group will not exist without at least one account linked to it or a historical relationship to an account.

(3) Dependent accounts must have dependent strategies.

(4) All accounts that statement together must have the same cycle code and method.

(5) All accounts in the group must have the same issuer number.

(6) Accounts within a group cannot be dual. A dual account is an account that corresponds to two different credit card products. For example, a dual account could correspond to a VISA™ product and a MASTERCARD™ product.

(7) Accounts within a group cannot be included in a Combine Account Transfer. A Combine Account Transfer is a process that merges two accounts into a single joint account.

(8) Accounts in the group cannot have a commercial card relationship.

(9) The key account cannot have a status of bankrupt, closed or charge off without impacting the dependent accounts.

Creating a Group Using New Accounts

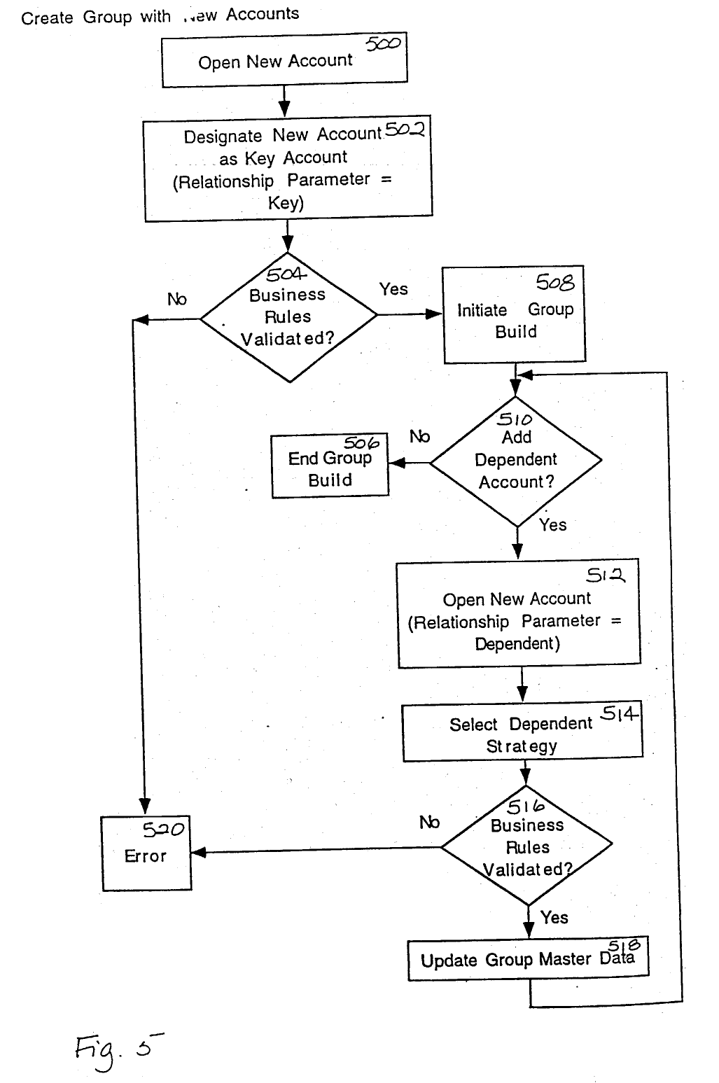

An exemplary method for creating a group using new accounts is shown in FIG. 5. In step 500, a new account is opened. The new account is designated as the key account in step 502 by setting a relationship parameter for the account to “key.” The relationship parameter defines the relationship between the account and the group. When the key account is opened, a number of account parameters and group parameters are automatically set. For example, parameters defining the cycle code and method and the currency code are typically defined at the time the account is opened. In step 504, the parameters set in step 500 are compared to the set of business rules. If the parameters set in step 500 satisfy the business rules, then the business rules are validated.

If the determination in step 504 is that the business rules are validated, then the “Yes” branch is followed to step 508. In step 508, the group build is initiated and the key financial record and the group master data are created. Typically, the key financial record includes the account parameters for the key account plus the relationship parameter and a group identifier. The group master data includes a group identifier and certain group parameters. If the determination in step 504 is that the business rules are not validated, then the “No” branch is followed to step 520 and an error occurs.

Although FIG. 5 illustrates that a key account is created in steps 500 and 502, a group can be created without a key account. If a key account is created, then the key account cardholder is the primary owner. However, if a group is created without a key account, a primary owner is required. A key financial record is created regardless of whether the group includes a key account.

The remaining steps in FIG. 5 illustrate adding dependent accounts to the group. In step 510, a determination is made as to whether a dependent account is to be added to the group. If a dependent account is to be added to the group, then the “Yes” branch is followed to step 512 and a new account is opened. The new account is designated as a dependent account by setting the relationship parameter for the account to dependent. From step 512, the method proceeds to step 514 where a dependent strategy is selected. Typically, an issuer provides a number of dependent strategies that can be used for dependent accounts within a group. Once a dependent strategy is selected, then a determination is made in step 516 as to whether the parameters selected in opening the dependent account and the dependent strategy satisfy the business rules. If the business rules are satisfied, then the business rules are validated in step 516 and the method proceeds to step 518. In step 518, the dependent financial record is created and the group master data is updated. Typically, the dependent financial record includes account parameters for the dependent account, as well as the relationship parameter, a group identifier, and a dependent strategy identifier. Updating the group master data includes creating the link between the dependent financial record for the dependent account and the group master data.

From step 518 the method returns to step 510 and a determination is made as to whether another dependent account is to be added. If another dependent account is to be added, then steps 512, 514, 516, and 518 are repeated. Once all the dependent accounts have been added, then the method proceeds from step 510 via the “No” branch to step 506 and the method ends.

FIG. 5 illustrates that business rules are validated after the key account or a dependent account is opened. Alternatively, if the accounts are opened in an on line environment, then the business rules can be validated as the accounts are opened. For example, an operator can be prevented from creating an invalid relationship, such as creating two key accounts. FIG. 5 also illustrates that the group master data is updated after the addition of each dependent account. However, the group master data can be updated at other times. For example, information for opening a key account and dependent accounts may be collected by the issuer and then submitted by the issuer to the card processing and service provider in batch. If the information is submitted in batch, then the group master data may be updated once with information for all of the accounts in the group.

Creating a Group Using Existing Accounts

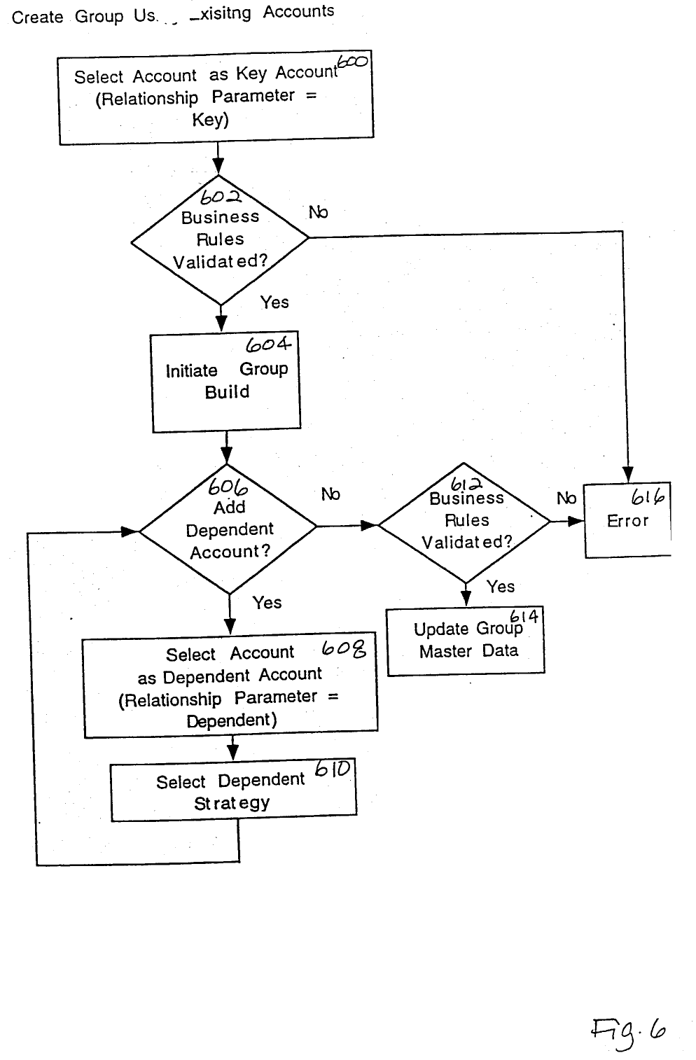

FIG. 6 illustrates the steps for creating a group using existing accounts. In step 600, an existing account is selected as the key account by setting the relationship parameter for the account to key. If the account was not previously a member of a group, then the relationship parameter was blank. Once an existing account is selected as the key account, then in step 602 a determination is made as to whether the business rules are validated. The business rules are validated if the parameters for the key account satisfy the business rules.

If the business rules are validated, then the method follows the “Yes” branch to step 604. In step 604, the group build is initiated. Initiating the group build includes creating the group master data, and linking the key account to the group by linking the key financial record to the group master data.

Once the initial group build is-complete, then a determination is made in step 606 as to whether a dependent account is to be added to the group. If a dependent account is to be added to the group, then the “Yes” branch is followed to step 608. In step 608, an account is selected as a dependent account. Once an account is selected as a dependent account, the relationship parameter for the selected account is set to dependent. In step 610, a dependent strategy is selected for the dependent account. From step 610 the method returns to step 606 and a determination is made as to whether another dependent account is to be added to the group.

Once all the dependent accounts have been added to the group, then the “No” branch is followed from step 606 to step 612. In step 612, a determination is made as to whether the business rules are validated. The business rules are validated in step 612, if the dependent accounts satisfy the business rules. If the business rules are validated in step 612, then the “Yes” branch is followed to step 614. In step 614, the group master data is updated with information for the dependent accounts. In addition, the dependent financial records for the dependent accounts are linked to the group master data. However, if the business rules are not validated in step 612, then the “No” branch is followed to step 616 and an error occurs.

Although FIG. 6 illustrates that the group master data is updated after all the dependent accounts have been selected, those skilled in the art will appreciate that the group master data could be updated at other points in the process. For example, if the group is being created using on line processing, then validating the business rules and updating the group master data could occur after step 610 for each dependent account added.

Changing Group Relationships

The relationships between the accounts of the group are flexible and can be modified. The relationship between a dependent account and the group can be changed by selecting a new dependent strategy. The ability to modify, the dependent strategy allows the account to change as the cardholder's situation changes. For example, if the initial dependent strategy was a strategy suitable for a high school age child living at home, then the dependent strategy could be modified to a strategy suitable for a college age child living at school once the child enters college and moves away from home. Changing the dependent strategy of one of the dependent accounts does not impact the dependent strategies of the other dependent accounts.

In addition, a dependent account can be added to the group or deleted from the group without affecting the remaining accounts in the group. The ability to add dependent accounts and delete dependent accounts allows the group to change to accommodate changes in the relationships between the primary owner and the dependent cardholders. To add a dependent account to a group, the dependent financial record for the dependent account is linked to the group master data. Adding a dependent account to a group may correspond to the primary owner or a dependent cardholder obtaining another card or may correspond to adding another dependent cardholder to the group. For example, a group could be established for a family that includes a mother, father and daughter. When the group is created, the group could include financial records corresponding to accounts held by the mother and father. Subsequently, a dependent financial record could be added for an account for the daughter.

To remove a dependent account from a group, the dependent financial record for the dependent account is delinked from the group master data. Removing a dependent account from a group may correspond to a change in family status. For example, a group could be established for a married couple with the husband as the primary owner and the wife as a dependent cardholder. If the couple divorces, then the group could be modified to delete the dependent financial records that correspond to accounts held by the wife. As will be apparent to those skilled in the art, a dependent account can also be removed from a group for reasons other than a change in family status.

A single account can be removed from a group or a number of accounts can be removed from a group. If an account is removed from a group, it can be moved to an existing group, used to create a new group, or can be designated as an independent account that is not a member of any group. If a dependent account is moved to an existing group, then the group identifier in the dependent financial record is changed to correspond to the group identifier for the existing group. If a dependent account is removed from one group and is used to create another group, then the dependent account can remain a dependent account or can be “matured” into a key account. To mature a dependent account into a key account, the relationship parameter for the dependent account is changed from dependent to key. If a dependent account is matured into a key account, the history for the dependent account that was accrued during the period that the dependent account was a member of the group follows the dependent account to the new group. If the dependent account is designated as an independent account, then the relationship parameter is set to blank.

If all the accounts in a group are removed from the group, then the group continues to exist for some pre defined period of time even though the group does not have any members. The group continues to exist so that audit history for the group can be maintained for the predefined period of time.

The primary owner of the group can be changed. The primary owner can be changed to a cardholder that corresponds to one of the dependent accounts or to a new primary owner. To change the primary owner to a dependent cardholder, the relationship parameter for the dependent account is changed from dependent to key. The original key account can be converted to a dependent account by changing the relationship parameter from key to dependent. Alternatively, the original key account can be removed from the group and transferred to another group (as either a key or dependent account) or established as an individual account in a manner similar to that described in the preceding paragraph.

A group history is maintained in the group master data. For example, as discussed above in connection with FIG. 4B, information on all the accounts that are or ever were members of the group are stored in the Group Member file. The history of any changes in the dependent strategy for a dependent account are maintained in the Member Relationship file and the history of any changes in the definition of a strategy is maintained in the Strategy Definition file. In addition to group history, account history is also maintained with each account. The account history follows the account notwithstanding changes in the account's membership in a group. For example, payment history for a dependent account follows the dependent account even if the dependent account is delinked from the group and is established as an individual account.

Adding a Dependent Account to a Group

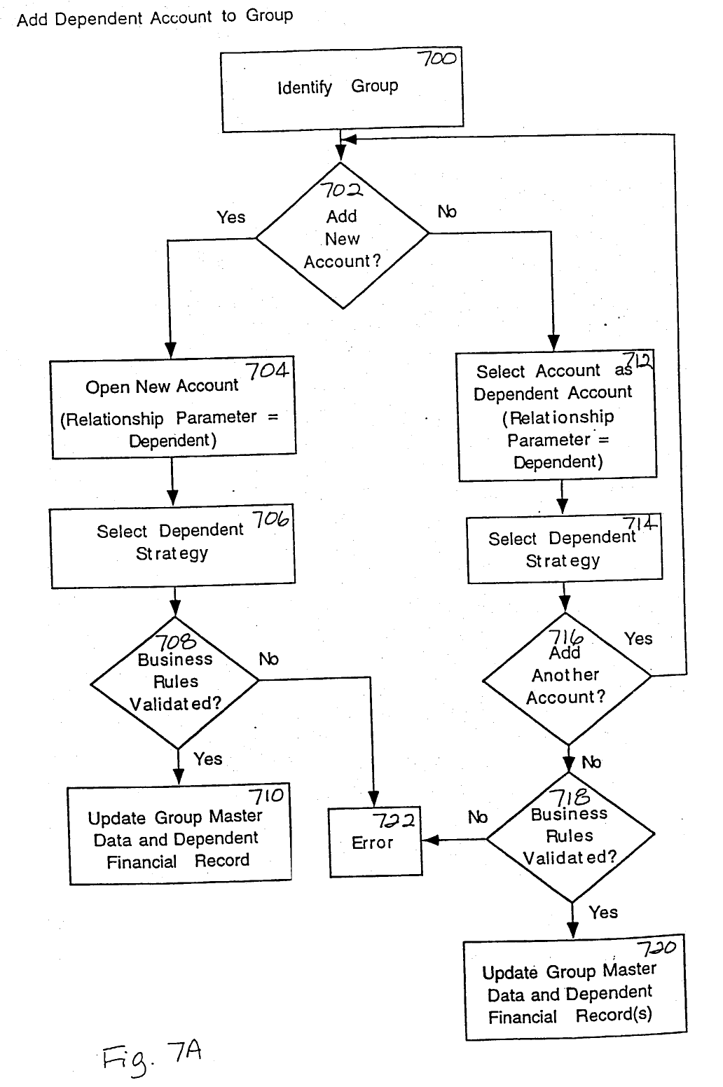

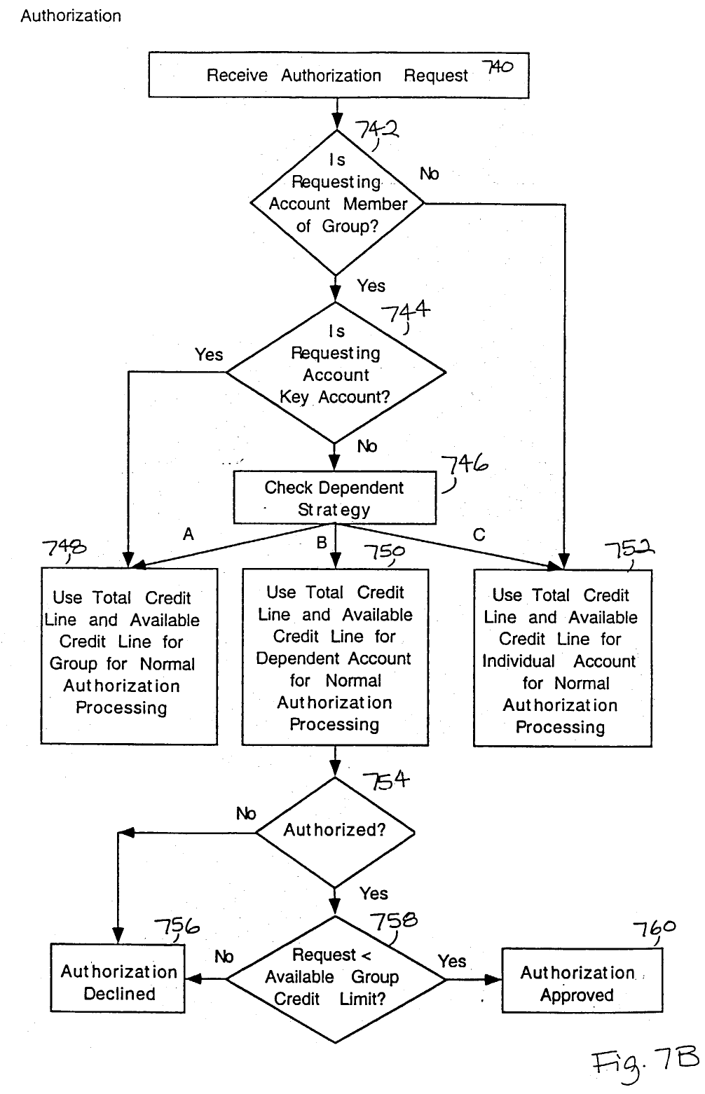

Once a group is created, additional dependent accounts can be added to the group. The additional dependent accounts can be newly created accounts or can be existing accounts. FIG. 7A illustrates the steps for adding a dependent account to an existing group. In step 700, a group is identified. Typically a group is identified using the group identifier. In step 702, a determination is made as to whether an existing account is to be added or whether a new account is to be added. If a new account is to be added, then the “Yes” branch is followed to step 704. In step 704, a new account is opened and the relations hip parameter for the account is set to dependent. A dependent strategy for the new account is selected in step 706. In step 708, a determination is made as to whether the dependent account opened in step 704 satisfies the business rules. If the dependent account satisfies the business rules, then the business rules are validated and the “Yes” branch is followed to step 710. In step 710, the group master data is updated. If the business rules are not validated in step 708, then the “No” branch is followed to step 722 and an error occurs.

If the determination in step 702 is that an existing account is to be added, then the “No” branch is followed to step 712. In step 712, an existing account is selected and the relationship parameter for the account is set to dependent. A dependent strategy for the account is selected in step 714. The parameters for the dependent account created in step 712 are compared to the business rules in step 718. If the parameters for the dependent account satisfy the business rules, then the business rules are validated and the “Yes” branch is followed to step 720. In step 720, the group master data is updated. However, if the business rules are not validated then the “No” branch is followed to step 722 and an error occurs.

Although FIG. 7A indicates that the group master data is updated after each dependent account is added to the group, the group master data can be updated at other points in the process. For example, if multiple accounts are to be added to an existing group, then the steps shown in FIG. 7A would be repeated for each account. Rather than updating the group master data after the addition of each dependent account, the group master data could be updated after the addition of all the dependent accounts. Updating the group master data after the addition of each account can be used to support on line processing, whereas updating the group master data after the addition of a number of dependent accounts can be used to support batch processing.

Group Processing

Once a group is created it can be used to perform group processing. Group processing typically includes authorizing transactions, applying group payments, creating group statements, controlling cardholder communications, and administering reward programs for the accounts in the group. Information from both the key account and the dependent accounts are used for group processing. Each dependent account has an associated dependent strategy that specifies group processing options for the dependent account. Although the accounts of a group are subject to group processing for some functions, the accounts are treated as individual accounts for other functions.

Authorizing a Transaction

The dependent strategy for a dependent account specifies the authorization option for the dependent account. The authorization option specifies the information that is used to authorize a transaction. In one embodiment of the invention, three authorization options are available for a dependent account. One authorization option considers only the credit line and available credit of the group, a second option considers only the credit line and available credit of the dependent account, and a third option considers the credit line and the available credit of both the group and the dependent account.

Depending upon the authorization option selected, the authorization processing uses the group credit line and the group available credit and/or the dependent credit line and the dependent available credit. The group credit line is a group parameter that typically is set when the group is created. The dependent credit line is a dependent account parameter that is set when the dependent account is opened. The group credit line and the dependent credit line can be modified. The group available credit is calculated real time using activity from the key account (if any) and any dependent accounts that share the group credit line. A dependent account shares the group credit line if payment for the dependent account is due from the primary owner. Generally, the group available credit is calculated by subtracting the current balances and any outstanding authorizations of the key account and the dependent accounts that share the group credit line from the group credit line. Similarly, the dependent available credit is calculated by subtracting the current balance and any outstanding authorizations of the dependent account from the dependent credit line.

FIG. 7B illustrates exemplary steps for authorizing a transaction. In step 740, an authorization request is received. The authorization request includes a transaction amount and an account identifier, such as an account number. In step 742, a determination is made as to whether the account identifier corresponds to an account that is a member of a group. If the requesting account is not a member of a group, then the “No” branch is followed to step 752. In step 752, normal authorization processing occurs using the credit line and the available credit for the account.

Normal authorization processing typically includes several calculations that use the credit line and the available credit. For example, authorization may include comparing the amount of the transaction to the available credit, comparing the amount of the transaction to a percentage expansion of the credit line, as well as comparing the transaction to past transactions for the account. Comparing the transaction to past transactions for the account may be used to detect possible fraudulent uses of a card and may result in the issuance of a referral code. As will be apparent to those skilled in the art, additional calculations can also be performed.

If the determination in step 742 is that the requesting account is a member of a group, then the “Yes” branch is followed to step 744. In step 744, a determination is made as to whether the requesting account is a key account or a dependent account. If the requesting account is a key account, then the “Yes” branch is followed to step 748. In step 748, normal authorization processing occurs using the group credit line and the group available credit.

If the determination in step 744 is that the requesting account is a dependent account, then the “No” branch is followed to step 746. In step 746, the dependent strategy is checked to determine the authorization option that corresponds to the dependent account. FIG. 7B illustrates three possible authorization options, A, B and C. Option A specifies that the credit line and the available credit for the group are used for authorization processing. Option B specifies that the credit line and the available credit for both the group and the dependent account are used for authorization processing. Option C specifies that the credit line and the available credit for the dependent account are used for authorization processing.

If the dependent strategy specifies option A, then the method proceeds from step 746 to step 748 and the credit line and the available credit for the group are used for normal authorization processing. If the dependent strategy specifies option C, then the method proceeds from step 746 to step 752 and the credit line and the available credit for the dependent account are used for normal authorization processing. The difference between the authorization processing performed in step 748 and the authorization processing performed in step 752 is that step 748 uses group information, whereas step 752 uses dependent account information.

If the dependent strategy specifies option B, then the method proceeds from step 746 to step 750 and the credit line and the available credit for both the group and the dependent account are used for authorization processing. In step 750, the credit line and the available credit for the dependent account are used in normal authorization processing. The authorization processing performed in step 750 is similar to that performed in step 752. However, additional processing is required for option B. In step 754, a determination is made as to whether the processing performed in step 750 indicates that the authorization request is authorized. If the processing performed using the dependent account information indicates that the request is authorized, then the “Yes” branch is followed to step 758. In step 758, a determination is made as to whether the transaction amount specified in the authorization request exceeds the group available credit. If the amount does not exceed the group available credit, then the “Yes” branch is followed to step 760 and the authorization request is approved. If the processing performed in step 754 indicates that the authorization request is denied or if the comparison performed in step 758 indicates that the amount of the request exceeds the group available credit, then the “No” branch is followed to step 756 and the authorization request is declined.

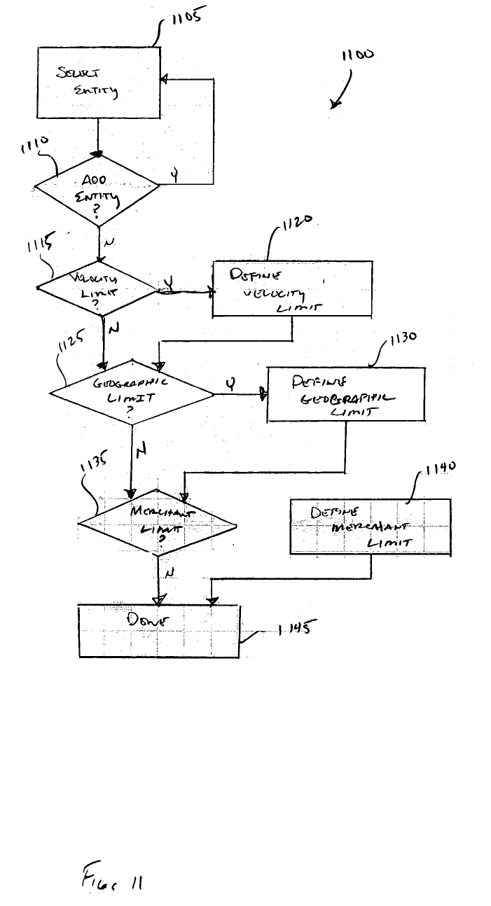

Turning to FIG. 11, a flow diagram 1100 illustrates a method in accordance to the present invention for defining a variety of authorization limits. Such limits can be defined by an account holder or a member of an account group. In some embodiments, a user interface is provided whereby an account holder or account group member can update the various limits. Following flow diagram 1100, an entity is selected to which a limit will be applied (block 1105). Such an entity can be a person, a presentation instrument, an electronic device, an automobile, or the like. Thus, for example, the entity to which a limit may be applied may be a presentation instrument, such as a credit card. Alternatively, an automobile or a person may be associated with a FOB device that identifies the automobile or person. As such, the entity may be the identified person or automobile. An electronic device, such as a personal computer, a personal digital assistant, a cell phone, or the like may include identification information that can be used in relation to an authorization. Based on the disclosure provided herein, one of ordinary skill in the art will recognize other entities to which limits can be applied in accordance with the present invention.

It is next determined if another entity is to be added (block 1110). Thus, a limit can be applied to a combination of two or more entities. For example, one of the entities may be a presentation instrument and the other a person. Where the presentation instrument is used by the person, a particular set of limits can be applied. In contrast, where the same presentation instrument is used by another person, a different set of limits can be applied. One of ordinary skill in the art upon reading this disclosure will recognize a myriad of entity combinations that are possible in accordance with the present invention. For example, a combination of an automobile and a person, or an automobile and a presentation instrument is possible. As another example, a combination of an automobile, a presentation instrument, and a person is also possible. Entities are added (block 1105) until all of the entities that are part of the combination are added (block 1110).

With the entity or entities defined, it is determined if a velocity limit is to be associated with the entity or entities (block 1115). Where a velocity limit is desired (block 1115), it is defined and stored to a system memory (block 1120). As previously discussed, such a velocity limit can be any time based limit. For example, where a presentation instrument is selected as the entity, a velocity limit of one-thousand dollars per week can be selected. As an alternate example, where a presentation instrument combined with a person is selected as the entity, a velocity limit of one-hundred dollars per week can be selected. Based on this disclosure, one of ordinary skill in the art will recognize a number of other velocity limits that can be applied.

It is also determined if a geographic limit is to be associated with the entity or entities (block 1125). Where a geographic limit is desired (block 1125), it is defined and stored to a system memory (block 1130). As previously discussed, such a geographic limit can be any location based limit. For example, where an automobile is selected as the entity, a geographic limit of one-hundred miles from an account owner's location can be selected. As an alternate example, where an automobile combined with a person is selected as the entity, a geographic limit of twenty miles from the owner's location can be selected. Based on this disclosure, one of ordinary skill in the art will recognize a number of other geographic limits, such as a zipcode limit, that can be applied.

It is also determined if a merchant limit is to be associated with the entity or entities (block 1135). Where a merchant limit is desired (block 1135), it is defined and stored to a system memory (block 1140). For example, where an automobile is selected as the entity, a merchant limit may be applied that limits purchases to gasoline, or even a particular brand of gasoline. As an alternate example, where a presentation instrument combined with a person is selected as the entity, a merchant limit may limit transactions to purchases of food, or to expenditures at a college bookstore. Based on this disclosure, one of ordinary skill in the art will recognize a number of other merchant limits that can be applied.

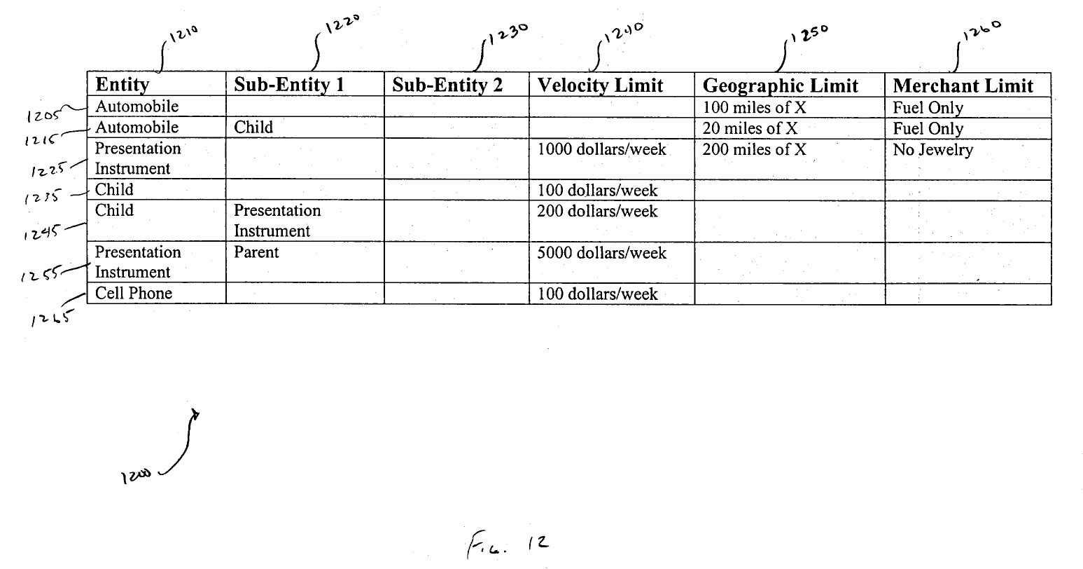

Turning now to FIG. 12, a data structure 1200 in accordance with various embodiments of the present invention is depicted. Data structure 1200 includes an entity field 1210, and sub-entity fields 1220, 1230, a velocity limit field 1240, a geographic limit field 1250, and a merchant limit field 1260. Data structure 1200 further includes a variety of defined entities and limitations 1205, 1215, 1225, 1235, 1245, 1255, 1265. Such entities provide a variety of examples of entity selection and limit selection in accordance with embodiments of the present invention. Based on the disclosure provided herein, one of ordinary skill in the art will recognize a number of other entities and/or limitations. Entity 1205 is an automobile that is limited to fuel purchases within a one-hundred mile radius. entity 1215 is an automobile in combination with a child that is limited to fuel purchases within a twenty mile radius. Entity 1225, is a presentation instrument that has a velocity limit of one-thousand dollars per week, within a two-hundred mile radius, and cannot be used for jewelry purchases. Entity 1235 is a child that has a velocity limit of one-hundred dollars per week. Entity 1245 is a child and a presentation instrument combination that has a velocity limit of two-hundred dollars per week. Entity 1255 is a presentation instrument and parent combination that has a velocity limit of five-thousand dollars per week. Entity 1265 is a cell phone that has a velocity limit of one-hundred dollars per week. Entity 1265 may alternatively be limited to a number of minutes per period. Thus, this limit could be pre-programmed to disallow use after an amount of free time has been expended.

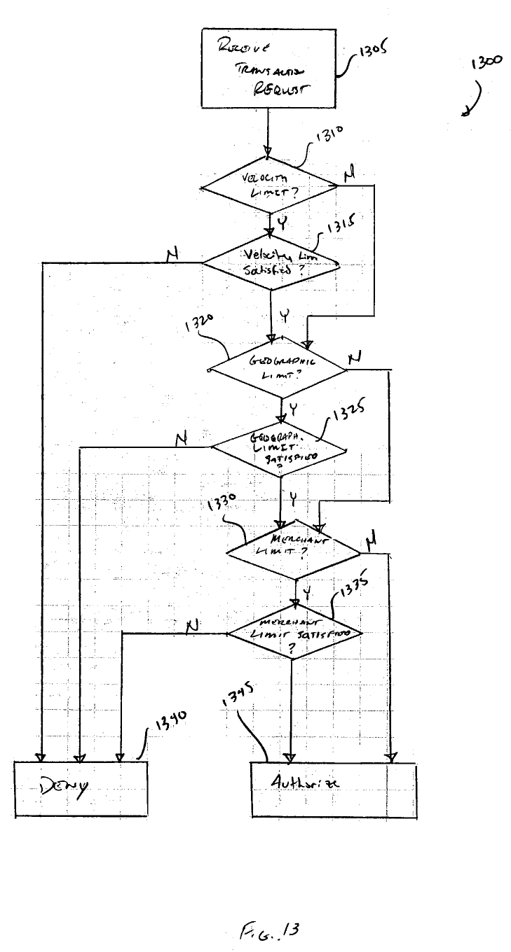

Turning to FIG. 13, a flow diagram 1300 depicts a method for authorizing transactions in accordance with the present invention. Following flow diagram 1300, a transaction request is received (block 1305). The transaction request can identify one or more elements related to the various limits. For example, the transaction request can identify a person and a presentation instrument, a person and an automobile, an electronic device, or any other entity or combination thereof. The identified entity or entities are used to query data structure 1200 to determine if one or more limits are to be used in relation to authorizing the transaction. For example, where the entity is an automobile, it is determined that only fuel can be purchased and only within a one-hundred mile radius, unless a child is also identified in relation to the transaction, in which cases the radius is twenty miles.

In one embodiment, limits associated with a combination of entities are employed where the entities included in the combination include other limits. Thus, for example, entity 1205 and entity 1215 conflict where the child is involved, as the automobile is subject to different limits when used by someone other than the child. In this case, the geographic limit is twenty miles as that is the limit associated with the combination. As another example, entity 1235 and entity 1255 conflict where the parent is involved. Again, the combination prevails and the limits associated with entity 1255 are applied.

Having determined the limits associated with the entity, it is determined whether a velocity limit exists (block 1310). Thus, for example, where entity 1215 is determined to be associated with the transaction request, a velocity limit is not involved. Alternatively, where entity 1235 is determined to be associated with the transaction request, a velocity limit is involved. Where a velocity limit is involved, the requested transaction is added to transactions occurring in a prior period, and it is determined if the combined transactions will exceed the velocity limit (block 1315). Where the transaction would cause the velocity limit to be exceeded (block 1315), the transaction request can be denied (block 1340). Thus, for example, where entity 1265 is determined to be associated with the transaction (block 1305), and an ongoing phone call will cause a more than one-hundred dollars to have been spent in the week, the transaction can be denied.

Where either no velocity limit exists (block 1310), or the velocity limit is satisfied (block 1315), it is determined whether a geographic limit exists (block 1320). Where a geographic limit exists, it is determined whether the transaction satisfies the geographic limit (block 1325). Where the geographic limit is not satisfied, the transaction can be denied (block 1340). Otherwise, where either no geographic limit exists (block 1320), or the geographic limit is satisfied (block 1325), it is determined whether a merchant limit exists (block 1330). Where a merchant limit exists, it is determined whether the transaction satisfies the merchant limit (block 1335). Where the geographic limit is not satisfied, the transaction can be denied (block 1340). Otherwise, where either no merchant limit exists (block 1330), or the merchant limit is satisfied (block 1335), the transaction is authorized. Of course, one of ordinary skill in the art will recognize that other limits can also be queried in relation to an authorization request. For example, it may be determined whether a credit limit has been exceeded. Also, it will be recognized that only one, or a subset of the aforementioned limits may be tested by a given system.

Applying a Payment

The dependent strategy for a dependent account specifies whether payment of the dependent account balance is due from the primary owner or is due from the dependent cardholder. If payment of the dependent account is due from the dependent cardholder, then the entire amount of a payment received from the dependent cardholder is credited to the dependent account. However, if the dependent account is paid by the primary owner, then the amount of the group payment that is credited to the dependent account depends upon the amount of the group payment, as well as the control settings for the group. Payment of the key account is due from the group payment.

The allocation of a group payment is partially determined by the amount of the payment and partially determined by the group payment options. The group payment options are typically set by the issuer. The group payment options could be part of the group control settings in the group master data. Alternatively, the group payment options could be stored in a separate file, such as a Product Control File, and associated with the group through the key account or through another means.

Only accounts included in the group balances during the processing of the last group statement are included in the automatic allocation of a group payment. The group balances for the last group statement can be determined from the Group Statement files in the group master data. The account balances for accounts in the group can be determined from the Member Statement files in the group master data.

Typically, the amount of the group payment is compared to one or more of the group balances. The group balances include the Last Statement Balance (LSB) and the Minimum Payment Due (MPD) for the group. The group balances may also include the group delinquency amount. The group LSB is determined by adding the LSB of the key account (if any) to the LSB of all dependent accounts in the group that are paid by the primary owner. If payment for a dependent account is due from the dependent cardholder, then the LSB of that dependent account is not included in the group LSB. The group MPD is calculated by adding the MPD for the key account (if any) to the MPD for each of the dependent accounts that are paid by the primary owner. The group delinquency amount is determined by adding the account delinquency of the key account (if any) to the account delinquency of the dependent accounts that are paid by the primary owner.

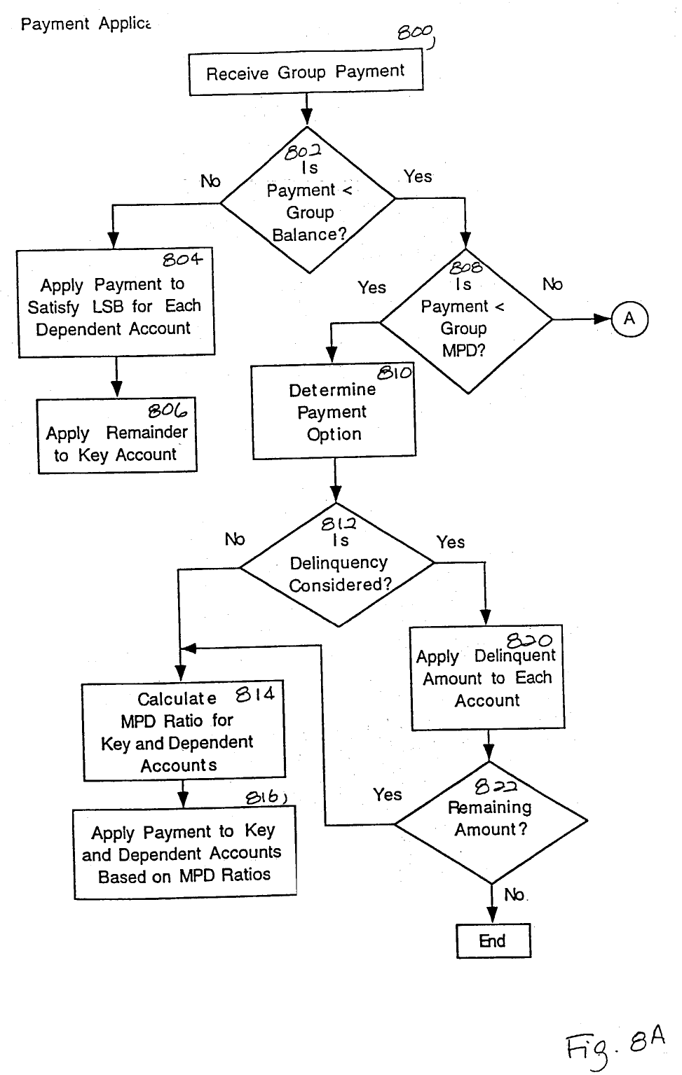

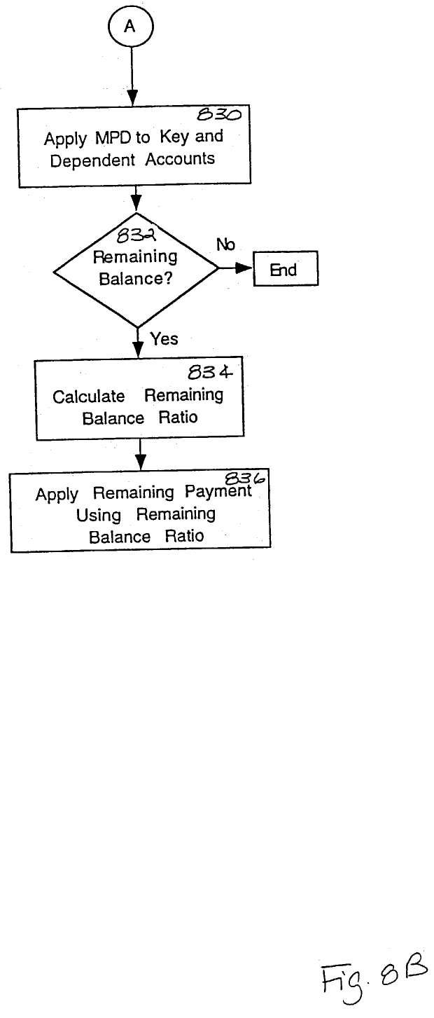

FIGS. 8A and 8B illustrate an exemplary method for applying a group payment. In step 800, the group payment is received. A determination is made in step 802 as to whether the payment is less than the group LSB. If the group payment is greater than or equal to the group LSB, then the “No” branch is followed to step 804. In step 804, the payment is applied to the dependent accounts in an amount equal to the LSB for each account. The remainder of the group payment is applied to the key account in step 806. If the payment is equal to the group LSB, then the amount applied to the key account is step 806 is equal to the LSB of the key account. However, if the group payment is greater than the group LSB, then the amount applied to the key account in step 806 is greater than the LSB of the key account. Although FIG. 8A illustrates that any overpayment is credited to the key account, an overpayment could be shared between the accounts of the group. Whether an overpayment is credited to the key account or shared between the accounts is typically determined by the group payment options.

If the determination in step 802 is that the group payment is less than the group LSB, then the “Yes” branch is followed to step 808. In step 808, a determination is made as to whether the group payment is less than the group MPD. If the group payment is less than the group MPD, then the “Yes” branch is followed to step 810. In step 810, the group payment options are determined. In step 812, a determination is made as to whether the group payment options indicate that account delinquency is considered in applying a group payment. If account delinquency is not considered, then the “No” branch is followed to step 814. In step 814, MPD ratios are calculated for the key account and the dependent accounts that are paid by the primary owner. An MPD ratio is calculated for an account by comparing the MPD for the account with the group MPD. Once the MPD ratios for the key account and the dependent accounts that are paid by the primary owner are calculated in step 814, then in step 816 the payment is applied to the key account and the dependent accounts in the group in accordance with the MPD ratios calculated in step 814.

If the determination in step 812 is that account delinquency is considered in applying the group payment, then the “Yes” branch is followed to step 820. In step 820, the group payment is applied to the key account and the dependent accounts paid by the primary owner to satisfy the delinquent amount for each account. In step 822, a determination is made as to whether there is any amount of the payment remaining. If there is an amount of the payment remaining, then the “Yes” branch is followed to step 814 and the remaining payment is allocated based upon the MPD ratios for the key account and the dependent accounts paid by the primary owner. If the determination in step 822 is that there is no remaining balance, then the method ends.

If the determination in step 808 is that the group payment is greater than or equal to the group MPD, then the “No” branch is followed to step 830 of FIG. 8B. In step 830, the group payment is allocated between the key account and the dependent accounts that are paid by the primary owner to satisfy the MPD for each account. A determination is made as to whether there is any amount of the group payment remaining in step 832. If there is an amount of the group payment remaining, then the method proceeds to step 834. In step 834, a remaining balance ratio is calculated for each of the accounts. A remaining balance ratio is calculated by comparing the remaining balance for an account to the remaining balance for the group. The remaining balance for an account is calculated by subtracting the MPD from the LSB for the account. The remaining balance for the group is calculated by subtracting the group MPD from the group balance. Once the remaining balance ratios are calculated in step 834, then the remainder of the payment is applied in accordance with the remaining balance ratios in step 836. If the determination in step 832 is that there is no remaining balance, then the method ends.

As will be apparent to those skilled in the art, other payment ratios could be considered when allocating a group payment among the accounts in the group other than those shown in FIGS. 8A and 8B. For example, as an alternative to steps 814 and 816, the group payment could be allocated based upon a LSB ratio rather than an MPD ratio or based upon an account hierarchy. An LSB ratio for an account can be calculated by comparing the LSB for the account to the LSB for the group. An account hierarchy specifies the order in which the accounts of a group are to be paid. Similarly, MPD ratios could be used as an alternative to the remaining balance ratios illustrated in FIG. 8B. Moreover, other account conditions could be considered in allocating a group payment. For example, in addition to or as an alternative to considering delinquent amounts, disputed amounts could be considered.

The exemplary method for payment application illustrated by FIGS. 8A and 8B is based upon the amount of the group payment, the dependent strategies and the group payment options. Preferably, the steps illustrated in FIGS. 8A and 8B can be overridden. For example, an operator could manually allocate a group payment between the key account and the dependent accounts in accordance with specific allocation instructions. The allocation instructions could be generated by the primary owner of the group or the issuer. If the group payment is an electronic payment, then instructions submitted with the electronic payment could determine how the payment is allocated. The allocation instructions could be for a single payment or could be standing instructions that apply to all payments received. If the allocation instructions are standing instructions, then the instructions could be stored in the group master data.

There are times when the application of a group payment needs to be reversed. For example, reversal of a payment is necessary if a check for the payment is returned for insufficient funds. If a check for a group payment is returned for insufficient funds, then the payment allocations to the accounts in the group are reversed. To reverse the payment allocations, the original payment allocation must be recreated. For example, if a group payment of $100 was allocated $50 to the key account, $25 to one dependent account and $25 to another dependent account, then reversal of the group payment is made by reversing the $50 payment allocation to the key account, the $25 payment allocation to the first dependent account and the $25 payment to the second dependent account. To reverse a payment, the Payment Allocation file is used to determine how the payment was originally allocated.

Generating Group Statements and Courted Statements

A group statement is created for the group and is sent to the primary owner. The group statement includes information about the activity of the key account (if any) and the activity of some or all of the dependent accounts of the group. The amount of information that appears on the group statement about a dependent account is controlled by the dependent strategy. Depending upon the dependent strategy, the group statement can include details of the activity of the dependent account or a summary of the activity of the dependent account.

Statement data is calculated for each account in the group. Statement data typically includes the MPD, LSB, reward information, finance charges, and late fees for the account. The statement data is calculated on an account by account basis. The statement data is used to create the group statement, a dependent statement, and/or a courtesy statement. The statement data is also used to calculate group data.

Group data includes the group MPD, group LSB, group reward information, group available credit, group finance charges and group late fees. The group data is calculated from the key account and any dependent accounts that are paid by the primary owner. The group statement also includes information about the previous group payment, including the amount, the posting date, etc. The group statement also includes information about the group, such as the primary owner, a listing of the accounts in the group, including the account numbers, and the dependent strategy for each dependent account in the group.

A dependent strategy specifies whether payment for the dependent account is due from the primary owner or from a dependent cardholder associated with the dependent account. The dependent strategy can also specify that a courtesy statement is generated. A courtesy statement is a statement that provides statement data to the cardholder, but does not require payment from the cardholder.

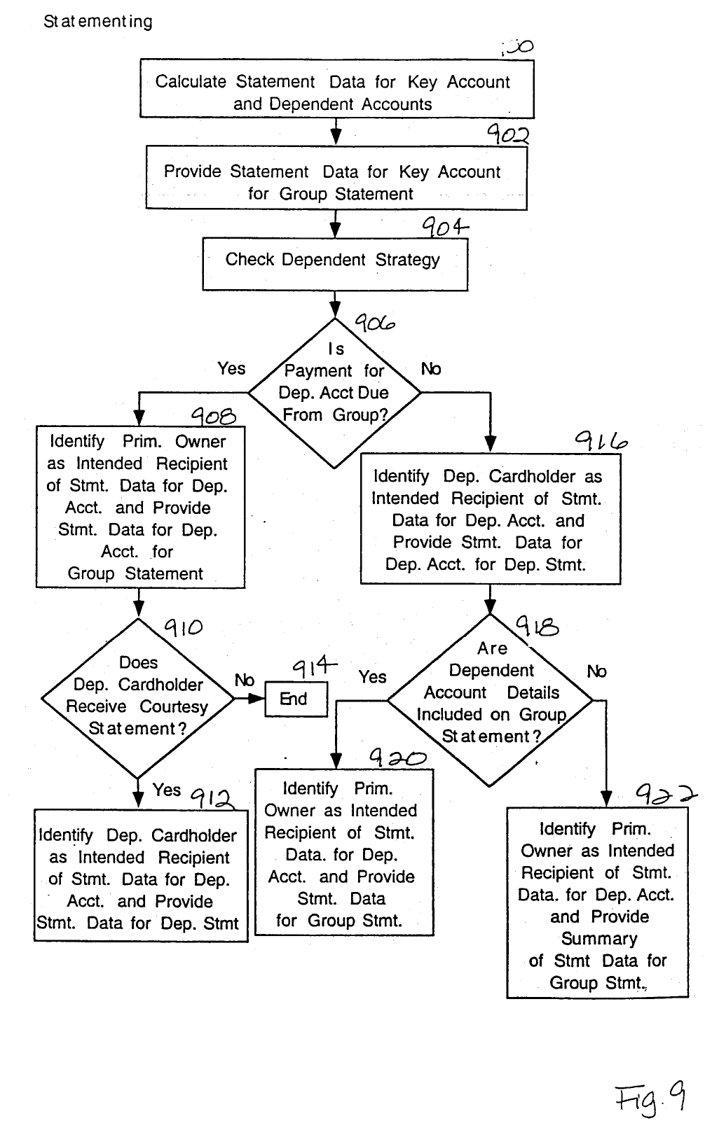

FIG. 9 illustrates exemplary steps for identifying the addressees or intended recipients of statement data and for providing statement data for inclusion on the group statement, a dependent statement, and a courtesy statement. In step 900, statement data for the key account (if any) and the dependent accounts are calculated. If the group includes a key account, then the statement data for the key account is provided for the group statement in step 900. In step 904, the dependent strategy for a dependent account is checked to determine whether payment for the dependent account is due from the primary owner or from a dependent cardholder associated with the dependent account.

If payment for the dependent account is due from the primary owner, then the “Yes” branch is followed to step 908. In step 908, the primary owner of the group is identified as an intended recipient of the statement data for the dependent account and the statement data for the dependent account is provided for inclusion on the group statement. In step 910, a determination is made as to whether the dependent strategy specifies that the dependent cardholder receives a courtesy statement. If the dependent strategy specifies that the dependent cardholder receives a courtesy statement, then the “Yes” branch is followed to step 912. In step 912, the dependent cardholder is identified as another intended recipient of the statement data for the dependent account and the statement data for the dependent account is provided for inclusion on the dependent statement. If the determination in step 910 is that the dependent strategy does not specify that the dependent cardholder receives a courtesy statement, then the “No” branch is followed to step 914 and the method ends.

If payment for the dependent account is due from a dependent cardholder associated with the dependent account, then the “No” branch is followed to step 916. In step 916, the dependent cardholder of the group is identified as an intended recipient of the statement data for the dependent account and the statement data for the dependent account is provided for inclusion on a statement for the dependent cardholder. In step 918, a determination is made as to whether the dependent strategy specifies that the details of the activity of the dependent account are included on the group statement. If the details of the activity of the dependent account are included on the group statement, then the “Yes” branch is followed to step 920. In step 920, the primary owner is identified as another intended recipient of the statement data for the dependent account and the statement data for the dependent account is provided for inclusion on the group statement. If the dependent account statements on the same day as the group, then current statement data is provided for inclusion on the group statement. However, if the dependent account statements on a different day than the group, then statement data associated with the last dependent statement is provided for inclusion on the group statement.

If the determination in step 918 is that the details of the activity of the dependent account are not included on the group statement, then the “No” branch is followed to step 922. In step 922, the primary owner is identified as another intended recipient of the statement data for the dependent account and a summary of the statement data for the dependent account is provided for inclusion on the group statement.

Step 904 illustrates that the dependent strategy for a dependent account is checked. As will be apparent to those skilled in the art, if the group includes multiple dependent accounts, then steps 904 through 922 are repeated for each dependent account.

Cardholder Communications

The dependent strategy for a dependent account also provides cardholder communication options for the dependent account. The communication options specify the intended recipient of an original communication, such as a letter, notice, or plastic, and, in the case of letters or notices, specify whether a courtesy copy of the communication is provided. A communication is typically generated to provide information to the cardholder. For example, a communication can be generated to advise a cardholder of changes to the cardholder agreement or to advise a cardholder of special offers.

The dependent strategy can specify that the original communication is sent to the primary owner. The dependent strategy can also specify that a courtesy copy of the communication is sent to the dependent cardholder. Alternatively, the dependent strategy can specify that the original communication is sent to the dependent cardholder. If the dependent strategy specifies that the original communication is sent to the dependent cardholder, the dependent strategy can also specify that a courtesy copy of the communication is sent to the primary owner.

In some instances, it may be necessary to generate multiple courtesy copies. This situation may occur if two parties are jointly liable on an account. For example, a dependent account could be jointly held by a first dependent cardholder and a second dependent cardholder. If the dependent strategy specifies that the first dependent cardholder receives the original communication and that the primary owner receives a courtesy copy, then in addition to the courtesy copy sent to the primary owner, a second courtesy copy is sent to the second dependent cardholder because the account is jointly held.

If the group includes multiple dependent accounts, then the dependent strategies for the dependent accounts can specify that the primary owner is to receive the original communication or a courtesy copy. Preferably, it is recognized that multiple communications are being sent to the primary owner so that the communications can be merged into a single communication that includes the communications for all the dependent accounts.

A group communication can include information about some or all of the accounts within a group. Typically, a group communication is sent to the primary owner of the group. Information about selected accounts of the group is obtained from the financial records corresponding to the accounts. The type of information obtained from the financial records can vary according to the type of communication. Typically, the type of information is specified by a processing option or variable associated with the communication. The information obtained from the financial records is combined into a single communication. The single communication can be automatically generated.

A group communication can also be manually created. The group communication can include information about the accounts within the group. To manually create a group communication, an operator can use a series of on line screens to specify the accounts and the type of information to be included in the communication.

In addition to letter communications, the primary owner and the dependent account cardholders may also receive notices. Notices are added to a group statement by considering what notices are required for the key account, what notices are required for each of the dependent accounts, and what notices are optional for the key account and the dependent accounts. If several accounts require the same notice, then preferably the notices are reviewed to insure that no duplicates are included.

Pooling Rewards, Accruing Rewards, and Redeeming Rewards

Reward programs allow parties to earn reward points based on purchases and other account activity. The processing of reward points at the account and/or group level can be determined by the reward program and the dependent strategies of the dependent accounts in a group. In some cases, the availability of group level pooling is determined by the reward program. It may be that some programs permit group pooling, whereas other programs do not. If the accounts in a group are members of multiple reward programs, then it is possible that some programs permit pooling while other programs do not.

If a reward program supports pooling, then any reward points earned by one or more accounts in an account group can be combined into the group reward pool. The dependent strategy specifies whether reward points earned by a dependent account are pooled or are maintained at the account level. In addition, the dependent strategy specifies whether the dependent account cardholder can redeem group reward points.

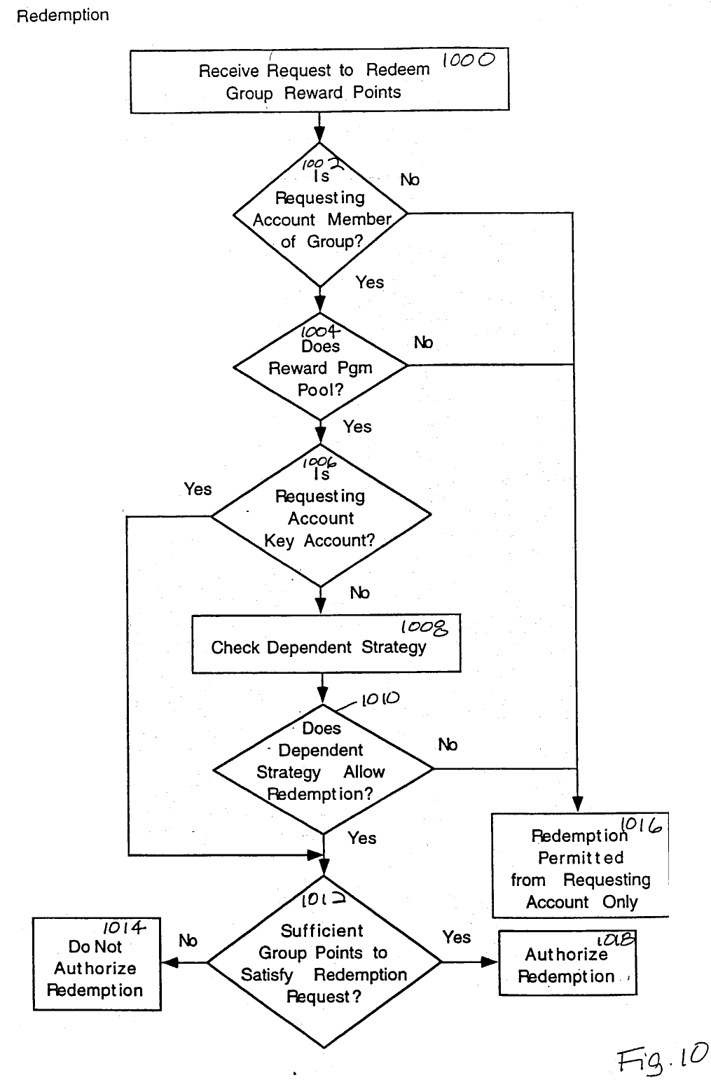

An exemplary method for redeeming group reward points is shown in FIG. 10. In step 1000, a request to redeem group reward points is received. In step 1002, a determination is made as to whether the request is associated with an account that is a member of the group. If the request is from an account that is a member of the group, then the “Yes” branch is followed to step 1004. In step 1004, a determination is made as to whether the reward program supports pooling. If the reward program supports pooling, then the “Yes” branch is followed to step 1006. In step 1006, a determination is made as to whether the account making the request is the key account. If the requesting account is the key account, then the “Yes” branch is followed from step 1006 to step 1012. However, if the requesting account is not the key account, then the requesting account is a dependent account and the “No” branch is followed from step 1006 to step 1008. In step 1008, the dependent strategy for the requesting dependent account is checked. A determination is made in step 1010 as to whether the dependent strategy specifies that the dependent account can redeem group reward points. If the dependent account can redeem group reward points, then the “Yes” branch is followed to step 1012.

In step 1012, a determination is made as to whether there are sufficient group points to satisfy the redemption request. If there are sufficient points, then the “Yes” branch is followed to step 1018 and the request to redeem group reward points is authorized. However, if there are not sufficient points, then the “No” branch is followed to step 1014 and the redemption request is not authorized.

If the determination in step 1002 is that the request to redeem group reward points is made by an account that is not a member of a group or the determination in step 1004 is that the reward program does not support reward point pooling, then the method proceeds to step 1016. Likewise, if the determination in 1010 is that the dependent account strategy does not allow the redemption of group reward points, then the method proceeds to step 1016. In step 1016 the requesting account is permitted to redeem points that are associated with the requesting account, but is not permitted to redeem group points.

As an alternative to reward point pooling, reward points can be shared between the accounts of a group via chasing. If chasing is implemented, then reward points earned by an account remain at the account level. The points can be chased or collected from the account level and used to satisfy a single redemption request.

Preferably, chasing is enabled or disabled by the reward program. If chasing is enabled by the reward program, then the accounts that participate in the reward program can support chasing. If an account supports chasing, then the account permits another account to redeem its earned reward points. If the account is a key account, then the option to support chasing could be part of the predefined relationship between the key account and the group. If the account is a dependent account, then the option to support chasing could be part of the dependent strategy. The ability to chase reward points could expand beyond the group to accounts that are not members of the group.

If a cardholder makes a redemption request that exceeds the reward points associated with the cardholder's account, then a determination is made as to whether the reward program supports chasing. If the reward program supports chasing, then the accounts that permit chasing in that reward program are identified. Points are chased from the identified accounts to satisfy the redemption request. The points are chased from the accounts based on a chasing option that specifies how the points are chased from the identified account. The chasing option could specify that the points are chased from the accounts on a pro rata basis, on the basis of an account hierarchy, or on some other basis. Chasing could be performed by an operator pursuant to instructions received by a cardholder. If chasing is performed by an operator, then the accounts that support chasing are displayed and the operator can select the accounts to chase. The operator can also determine the number of points chased from each account. Of course, while FIG. 10 is directed to reward access in a group environment, such reward access can also be applied to redeeming rewards from a single account associated with a redeeming party, or even an account or account group unrelated to the redeeming party.

Group Non-Monetary Transactions

In addition to group monetary transactions, such as authorizing a transaction or allocating a payment, group non-monetary transactions are also needed to support groups. A non-monetary transaction is a transaction that affects information for one or more accounts within the group, but does not affect the monetary information for the account. For example, a change in billing address is a non-monetary transaction, whereas the application of a payment is a monetary transaction. Other examples of non-monetary transactions include linking an account to an existing group, delinking one or more accounts from a group, changing the primary owner of a group, or changing the dependent strategy for a dependent account.

Group non-monetary transactions can be used in both batch and on line processing. Group non-monetary transactions update multiple accounts within a group in response to a single input of the updated information. To update the accounts in a group with updated group information, the accounts within the group are identified. The accounts are identified using the group master data. As described in connection with FIG. 4B, the accounts in a group can be identified using the Group Member file. Once the financial records are identified, then the financial records are updated with the new information.

Group non-monetary transactions also support the selective updating of accounts within the group. For example, if only certain accounts within the group are to receive the updated information, then the accounts in the group are identified and one or more of the accounts is selected and the selected account(s) is updated with the new information. In an on-line environment, an operator can select the accounts that are to receive the updated information. In a batch environment, the updated information and the account numbers for the selected accounts can be submitted in batch.

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A system for authorizing financial transactions, the system comprising:
a microprocessor based device coupled to a modem accessible via one or more network devices, wherein the microprocessor based device is associated with a first computer readable medium, and wherein the first computer readable medium includes instructions executable by the microprocessor based device to receive a request to perform a financial transaction in relation to an entity;
a second computer readable medium, wherein the second computer readable medium includes a history of transactions associated with the entity; and
wherein the first computer readable medium further includes instructions executable by the microprocessor based device to access the history of transactions, and based at least in part on the history of transactions to determine a velocity limit associated with the entity and to authorize the request based at least in part on the velocity limit.

2. The system of claim 1, wherein the microprocessor based device is a network server.

3. The system of claim 1, wherein the microprocessor based device is a network server.

4. The system of claim 3, wherein the request to perform a financial transaction is received from a retailer.

5. A method for authorizing financial transactions, the method comprising:
receiving a request to perform a financial transaction in relation to an entity;
determining a velocity limit associated with the entity; and
authorizing the financial transaction, wherein authorizing the financial transaction is based at least in part on a previous financial transaction incurred in relation to the entity over at least a five day period.

6. The method of claim 1, wherein the entity is selected from a group consisting of:
a presentation instrument, an automobile, an account, a mobile electronic device, and a person.

7. The method of claim 1, wherein the velocity limit is a first velocity limit, the. method further comprising:
determining that the entity is associated with an account group, wherein the account group includes a second velocity limit; and
wherein authorizing the financial transaction is further based at least in part on the second velocity limit.

8. The method of claim 1, wherein the velocity limit is selected from a group consisting of: an amount per month, an amount per week, a percentage of credit limit per month, and a percentage of credit limit per month.

9. The method of claim 1, wherein the entity is a combination of at least two of the following:
a presentation instrument, an automobile, an account, and a person.

10. The method of claim 1, wherein the entity is a person, and wherein the velocity limit is different for the person utilizing a first presentation instrument than for the person utilizing a second presentation instrument.

11. The method of claim 1, wherein the entity is a presentation instrument, and. wherein the velocity limit is different for the presentation instrument when used by a first person than for the presentation instrument when used by a second person.

12. The method of claim 1, the method further comprising:
determining a geographic limit associated with the entity; and
authorizing the financial transaction, wherein authorizing the financial transaction is based at least in part on a geographic location associated with the request.

13. The method of claim 1, the method further comprising:.
determining a merchant limit associated with the entity; and
authorizing the financial transaction, wherein authorizing the financial transaction is based at least in part on a merchant associated with the request.

14. A method for authorizing financial transactions, the method comprising:.
receiving a request to perform a financial transaction in relation to an entity;
determining a geographic limit associated with the entity; and
authorizing the financial transaction, wherein authorizing the financial transaction is based at least in part on a geographic location of the request.

15. The method of claim 10, wherein the entity is a person, and wherein the. geographic limit is different for the person utilizing a first presentation instrument than for the person utilizing a second presentation instrument.

16. The method of claim 10, wherein the entity is a presentation instrument, and. wherein the geographic limit is different for the presentation instrument when used by a first person than for the presentation instrument when used by a second person.

17. The method of claim 10, the method further comprising:.
determining a velocity limit associated with the entity; and
authorizing the financial transaction, wherein authorizing the financial transaction is based at least in part on a previous financial transaction incurred in relation to the entity.

18. The method of claim 10, the method further comprising:.
determining a merchant limit associated with the entity; and
authorizing the financial transaction, wherein authorizing the financial transaction is based at least in part on a merchant associated with the request.

19. A method for authorizing financial transactions, the method comprising:.
receiving a request to perform a financial transaction in relation to an entity;
determining a merchant limit associated with the entity; and
authorizing the financial transaction, wherein authorizing the financial transaction is based at least in part on a merchant associated with the request.

20. The method of claim 15, wherein the entity is selected from a group . consisting of: a person, an account, a presentation instrument, and an automobile.

21. The method of claim 15, the method further comprising:.
determining a velocity limit associated with the entity; and
authorizing the financial transaction, wherein authorizing the financial transaction is based at least in part on a previous financial transaction incurred in relation to the entity.

22. The method of claim 15, the method further comprising:.
determining a geographic limit associated with the entity; and
authorizing the financial transaction, wherein authorizing the financial transaction is based at least in part on a geographic location of the request.

23. The method of claim 15, wherein the entity is a person, and wherein the. merchant limit is different for the person utilizing a first presentation instrument than for the person utilizing a second presentation instrument

24. The method of claim 15, wherein the entity is a presentation instrument, and. wherein the merchant limit is different for the presentation instrument when used by a first person than for the presentation instrument when used by a second person.

25. A method for defining an authorization process, the method comprising:.
providing a user interface, wherein the user interface queries for an entity, and a limit in relation to the entity; and
receiving the limit.

26. The method of claim 21, wherein the user interface is a webpage interface.

27. The method of claim 21, wherein the entity is a combination of two or more. entities.

28. The method of claim 21, wherein the limit is selected from a group. consisting of: a velocity limit, a geographic limit, and a merchant limit.

29. The method of claim 21, wherein the limit is a first limit, the method further. comprising:
receiving a second limit in association with the entity.
